(19) United States
(12) Patent Application Publication
(10) Pub. No.: US 2007/0168363 A1
(43) Pub. Date: Jul. 19, 2007

(54) Database constructing apparatus, database search apparatus, database apparatus, method of constructing database, and method of searching database

(76) Inventors: Mitsuaki Inaba, Tokyo (JP); Yuji Kanno, Kanagawa (JP)

Correspondence Address: RATNERPRESTIA, P.O. BOX 980, VALLEY FORGE, PA, 19482, US

(21) Appl. No.: 10/587,770

(22) PCT Filed: Sep. 27, 2005
(86) PCT No.: PCT/JP05/17696

§ 371 Date: Jul. 28, 2006

(30) Foreign Application Priority Data
Nov. 30, 2004 (JP) 2004-345392
Apr. 28, 2005 (JP) 2005-131992

(51) Int. Cl. G06F 7/00

(52) U.S. Cl. 707/100

(57) ABSTRACT

A database apparatus has an element appearance information storage portion in which element appearance information is stored using element name IDs as keys, an ancestral path appearance information storage portion in which element appearance information is stored using ancestral path name IDs of the elements as keys, an attribute appearance information storage portion in which attribute appearance information is stored using attribute name IDs as keys, and a text appearance information storage portion in which appearance information about text character strings of element entities and the values of attributes possessed by the elements is stored using the partial character strings as keys.

### TECHNICAL FIELD

The present invention relates to a database apparatus for managing structured documents each having a logical structure such as XML documents and, more particularly, to a database constructing apparatus for storing and managing a large amount of structured documents and to a database search apparatus for efficiently searching structured documents stored therein.

### BACKGROUND ART

Japanese Patent Unexamined Publication No. 2002-202973 discloses a structured document managing apparatus for registering structured documents based on their logical structure and making full text search with a specified logical structure.

FIG. 33 is a diagram of the prior art structured document managing apparatus. Structured document input portion 2402 enters a structured document to be registered. Structure analysis portion 2407 analyzes the entered structured document into a tree structure. Within search engine 2405, structure information creation portion 2408 assigns name IDs to tag names (element names) of elements and stores the elements in name ID table storage portion 2418 within data storage portion 2406. With respect to the path names of the elements (i.e., a string of characters described by a sequence of tag names from the highest level of hierarchy), path name IDs are assigned, and the elements are stored in path name index storage portion 2416. A path hierarchy ID is assigned to the path hierarchy of each element, i.e., a string of characters described in the order of appearance of each level of hierarchy of the path name, and the string is stored in path hierarchy index storage portion 2417. The order of appearance of each level of hierarchy of path name indicates the position of an element within elements of the same tag name having the same parent element. In the case of an element having an entity (text) (hereinafter referred to as an “element entity”), codes each uniquely indicating a unit of search (hereinafter referred to as a “search unit identifier”) are assigned to element entities and the entities are stored in element management table storage portion 2415. FIG. 34 is a diagram illustrating an example of an element management table in the prior art structured document management apparatus. In FIG. 34, element management table 2501 is made up of sets of document numbers 2503, path name IDs 2504, path hierarchy IDs 2505, and name IDs 2506. Search unit identifiers 2502 are used as keys.

Character string index creation portion 2409 extracts a chain of characters consisting of a predetermined number of characters from character strings that are the contents of element entities. Character string index creation portion 2409 stores a search unit identifier corresponding to the chain of characters and a number indicating the position of the first character of the chain of characters within the contents of the elements (hereinafter referred to as the “character position number”) in character chain search storage portion 2419. FIG. 35A shows an example of structured document. FIG. 35B is a diagram showing an example of character string search in the prior art structured document managing apparatus. In FIG. 35B, record 2606 of character string index 2602 indicates that search unit identifier 2604 contains a chain of characters 2603 “structure” within the character string of element “1” and that character position number 2605 is “1” (i.e., a character is present in the 1st position from the forefront of the elements).

A search using data stored in this way is next described summarily. Operations of search processing in the prior art structured document managing apparatus are described by referring to FIGS. 36A-36C. FIG. 36A is a diagram showing an example of setting of search conditions. In FIG. 36A, search conditions 2701 specifying a structure indicate a “document having an element of path name “/treatise/bibliography/title”, the element containing a string of characters “structured””. Search condition analysis portion 2410 refers to path name index storage portion 2416 and converts the path name of the search conditions to path name ID “N2” (2702). Then, character string index search portion 2411 extracts a chain of two characters “structure(-)” and “(-)tured” from “structured”. The search portion refers to character chain indices and finds a search unit identifier of the same entry in which “structure(-)” and “(-)tured” appear in succession (2703). In this example, it is assumed that search unit identifiers “1” and “8” have been found as plural results of search of character string indices as shown in FIG. 36C.

Then, structure collation portion 2412 finds results of search satisfying the specifications of structures of search conditions 2702 and 2703. Here, structure collation portion 2412 searches element management table 2501 shown in FIG. 36B using search unit identifiers obtained as results of search of character string indices as keys. An entry having a path name ID coincident with “N2” is determined as a result of a search. The result of the search is shown in FIG. 36C. Where the search conditions specify a tag name, structure collation portion 2412 takes an entry containing an element management table whose name ID matches the name ID of the specified tag name as the result of search. Where the search conditions specify both path name and path hierarchy, structure collation portion 2412 takes an entry containing an element management table having a path name ID matched with the path name ID of the specified path name as the result of search, the element management table having a path hierarchy ID matched with the path hierarchy ID of the specified path hierarchy.

Japanese Patent Unexamined Publication No. 2004-310607 discloses a document management apparatus for creating an index that links an element contained in a structured document with a hierarchical position. This document management apparatus can manage plural elements while discriminating them from each other even if search routes from them to the hierarchical position are the same, i.e., there are plural child nodes for one parent node.

The above-described prior-art structured document management apparatus first refers to character string indices, finds each search unit identifier at which a specified character string appears, and then makes a decision as to whether the search unit identifier satisfies the specified structural conditions by referring to the element management table. Therefore, it is necessary to specify character string search conditions when a document search is made. It is impossible to make a search while specifying only structural conditions. That is, in order to make a search while specifying only structural conditions, a decision is made as to whether every search unit identifier satisfies the structural conditions after searching the whole element management table. Consequently, there is the problem that the efficiency is very low.

When data about structured documents is stored, a data structure is used in which logical structure data is attached to search index data used for full text search. Therefore, it is impossible to configure search data in such a way that a search can be made efficiently while specifying only structural conditions.

Furthermore, it is impossible to make a character string search regarding element attribute values because each character string index is created only for a character string indicating the contents of an element entity.

### DISCLOSURE OF THE INVENTION

A database constructing apparatus of the present invention has an input document analysis portion for assigning a unique document number to each structured document and analyzing its structure, an element name registration portion for assigning a unique element name ID to each element name appearing in the structured document based on results of the analysis performed by the input document analysis portion and registering the document name in an element name dictionary, an ancestral path name registration portion for assigning a unique ancestral path name ID to each ancestral path name appearing in the structured document based on the results of the analysis performed by the input document analysis portion and registering the ancestral path name in an ancestral path name dictionary, and an appearance information registration portion for registering element appearance information in an element appearance information storage portion using an element name ID as a key based on the results of the analysis performed by the input document analysis portion and for registering ancestral path appearance information in an ancestral path appearance information storage portion using an ancestral path name ID as a key. The element appearance information includes at least information about a document number at which an element of interest appears, a character position, the ancestral path name ID, and the order of branches. The ancestral path appearance information includes at least information about document numbers, character positions, element name IDs, and the order of branches.

In this database constructing apparatus, when a structured document is registered and stored, an appropriate appearance information index is created based on information about the appearance of elements. Accordingly, the database constructing apparatus of the present invention can build search data permitting efficient search of desired documents even under various search conditions in which only structural conditions not involving character string search conditions are specified, as well as in cases where character string search conditions and structural conditions are both specified.

### BRIEF DESCRIPTION OF THE DRAWINGS

FIG. 1 is a block diagram showing the configuration of a database apparatus in embodiment 1 of the present invention.

FIG. 2 is a flowchart illustrating procedures for processing for registering documents in embodiment 1 of the invention.

FIG. 3 is a diagram showing an example of structured document to be registered and searched in embodiment 1 of the invention.

FIG. 4 is a diagram showing an example of result of analysis of the logical structure of a structured document in embodiment 1 of the invention.

FIG. 5 is a diagram illustrating an ancestral path name in embodiment 1 of the invention.

FIG. 6 is a diagram showing an example of the contents of an element name dictionary in embodiment 1 of the invention.

FIG. 7 is a diagram showing an example of the contents of an ancestral path name dictionary in embodiment 1 of the invention.

FIG. 8 is a diagram showing an example of the contents of an attribute name dictionary in embodiment 1 of the invention.

FIG. 9 is a diagram illustrating a character position in embodiment 1 of the invention.

FIG. 10A is a diagram illustrating information about appearance of an element in embodiment 1 of the invention.

FIG. 10B is a diagram illustrating information about appearance of an element in embodiment 1 of the invention.

FIG. 11 is a diagram illustrating information about appearance of an ancestral path in embodiment 1 of the invention.

FIG. 12A is a diagram illustrating information about appearance of an attribute in embodiment 1 of the invention.

FIG. 12B is a diagram illustrating information about appearance of an attribute in embodiment 1 of the invention.

FIG. 13 is a diagram illustrating information about appearance of a text in embodiment 1 of the invention.

FIG. 14 is a diagram showing examples of search formulas in embodiment 1 of the invention.

FIG. 15 is a flowchart illustrating procedures for search processing performed by a database apparatus in embodiment 1 of the invention.

FIG. 16A is a diagram illustrating an example of search conditions in embodiment 1 of the invention.

FIG. 16B is a diagram illustrating search operation of a database apparatus in embodiment 1 of the invention.

FIG. 16C is a diagram illustrating results of a search in embodiment 1 of the invention.

FIG. 17A is a diagram illustrating an example of search conditions in embodiment 1 of the invention.

FIG. 17B is a diagram illustrating the search operation of a database apparatus in embodiment 1 of the invention.

FIG. 17C is a diagram illustrating results of a search in embodiment 1 of the invention.

FIG. 18A is a diagram illustrating an example of search conditions in embodiment 1 of the invention.

FIG. 18B is a diagram illustrating the search operation of a database apparatus in embodiment 1 of the invention.

FIG. 18C is a diagram illustrating the results of a search in embodiment 1 of the invention.

FIG. 19A is a diagram illustrating an example of search conditions in embodiment 1 of the invention.

FIG. 19B is a diagram illustrating the search operation of a database apparatus in embodiment 1 of the invention.

FIG. 19C is a diagram illustrating the result of a search in embodiment 1 of the invention.

FIG. 20A is a diagram illustrating an example of search conditions in embodiment 1 of the invention.

FIG. 20B is a diagram illustrating the search operation of a database apparatus in embodiment 1 of the invention.

FIG. 20C is a diagram illustrating the result of a search in embodiment 1 of the invention.

FIG. 21A is a diagram illustrating an example of search conditions in embodiment 1 of the invention.

FIG. 21B is a diagram illustrating the search operation of a database apparatus in embodiment 1 of the invention.

FIG. 21C is a diagram illustrating the result of a search in embodiment 1 of the invention.

FIG. 22A is a diagram illustrating an example of search conditions in embodiment 1 of the invention.

FIG. 22B is a diagram illustrating the search operation of a database apparatus in embodiment 1 of the invention.

FIG. 22C is a diagram illustrating the results of a search in embodiment 1 of the invention.

FIG. 23A is a diagram illustrating an example of search conditions in embodiment 1 of the invention.

FIG. 23B is a diagram illustrating the search operation of a database apparatus in embodiment 1 of the invention.

FIG. 23C is a diagram illustrating the results of a search in embodiment 1 of the invention.

FIG. 24 is a diagram used for illustration of the order of empty elements in embodiment 2 of the present invention.

FIG. 25A is a diagram illustrating a partial ancestral path name in embodiment 2 of the invention.

FIG. 25B is a diagram showing the contents of an ancestral path name dictionary in embodiment 2 of the invention.

FIG. 25C is a diagram illustrating a string of ancestral path name IDs in embodiment 2 of the invention.

FIG. 26 is a diagram illustrating information about appearance of elements in embodiment 2 of the invention.

FIG. 27 is a diagram illustrating information about appearance of an ancestral path in embodiment 2 of the invention.

FIG. 28 is a diagram showing an example of search formula in embodiment 2 of the invention.

FIG. 29A is a diagram illustrating the search operation in embodiment 2 of the invention.

FIG. 29B is a diagram illustrating the result of a search in embodiment 2 of the invention.

FIG. 30 is a block diagram showing the configuration of a database apparatus in embodiment 3 of the present invention.

FIG. 31 is a flowchart illustrating procedures for processing for registering documents in a database apparatus in embodiment 3 of the invention.

FIG. 32 is a diagram illustrating grouped element appearance information in embodiment 3 of the invention.

FIG. 33 is a block diagram of the prior art structured document managing apparatus.

FIG. 34 is a diagram showing an example of element management table in the prior art structured document managing apparatus.

FIG. 35A is a diagram showing an example of structured document processed by the prior art structured document managing apparatus.

FIG. 35B is a diagram showing an example of character string index in the prior art structured document managing apparatus.

FIG. 36A is a diagram illustrating an example of search conditions in the prior art structured document managing apparatus.

FIG. 36B is a diagram illustrating the search operation in the prior art structured document managing apparatus.

FIG. 36C is a diagram illustrating the result of a search in the prior art structured document managing apparatus.

### DESCRIPTION OF REFERENCE NUMERALS AND SIGNS

101: plural structured documents
102: input document analysis portion
103: element name registration portion
104: ancestral path name registration portion
105: attribute name registration portion
106: appearance information registration portion
107: element name dictionary
108: ancestral path name dictionary
109: attribute name dictionary
110: appearance position index
111: element appearance information storage portion
112: ancestral path appearance information storage portion
113: attribute appearance information storage portion
114: text appearance information storage portion
115: search formula
116: search condition input portion
117: search condition analysis portion
118: appearance information acquisition portion
119: search result output portion
120: search result
2101, 2102, 2103, 2104, 2105, 2106, 2107, 3201: search formulas
3401: appearance information grouping portion

### BEST MODE FOR CARRYING OUT THE INVENTION

### Embodiment 1

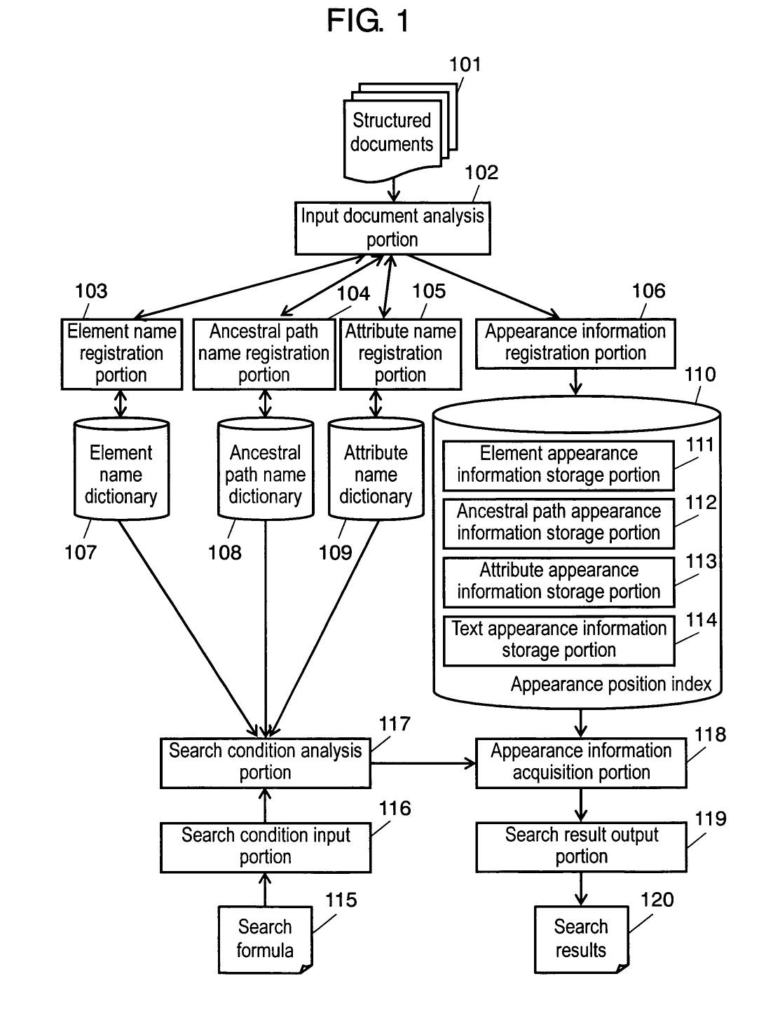

FIG. 1 is a block diagram showing the configuration of a database apparatus in embodiment 1 of the present invention. In FIG. 1, the database apparatus in the present embodiment has input document analysis portion 102 for entering plural structured documents 101 to be registered in a database, assigning a unique document number to each one of entered structured documents 101, and analyzing the logical structure, element name registration portion 103 for assigning a unique identifier (hereinafter referred to as the “element name ID”) to each element name appearing in each document according to the results of the analysis performed by input document analysis portion 102 and registering the element name IDs in element name dictionary 107, ancestral path name registration portion 104 for assigning a unique identifier (hereinafter referred to as the “ancestral path name ID”) to each ancestral path name (a string of characters of element names of ancestral elements of interest arrayed from the highest level of hierarchy and partitioned by slash marks; the element names themselves of the elements of interest are not contained) appearing in each document according to the result of the analysis performed by input document analysis portion 102 and registering the ancestral path names in ancestral path name dictionary 108, attribute name registration portion 105 for assigning a unique identifier (hereinafter referred to as the “attribute name ID”) to each attribute name appearing in each document according to the result of the analysis performed by input document analysis portion 102 and registering the attribute names in attribute name dictionary 109, and appearance information registration portion 106 for registering four kinds of appearance information in element appearance information storage portion 111 of appearance position index 110, ancestral path appearance information storage portion 112, attribute appearance information storage portion 113, and text appearance information storage portion 114 according to the results of the analysis performed by input document analysis portion 102. Furthermore, the database apparatus includes element name dictionary 107 in which the element name IDs and their respective element names are recorded, ancestral path name dictionary 108 in which ancestral path name IDs and their respective ancestral path names are recorded, attribute name dictionary 109 in which attribute name IDs and their respective attribute names are recorded, and appearance position index 110 in which four kinds of appearance information are respectively stored. Each of appearance position index 110 has element appearance information storage portion 111, ancestral path appearance information storage portion 112, attribute appearance information storage portion 113, and text appearance information storage portion 114. Element appearance information storage portion 111 stores information about document numbers at which elements respectively appear, character positions, number of characters, ancestral path name IDs, and order of branches using keys consisting of element name IDs. Ancestral path appearance information storage portion 112 stores information about document numbers at which elements respectively appear, character positions, number of characters, element name IDs, and order of branches, using keys consisting of ancestral path name IDs of the elements. Attribute appearance information storage portion 113 stores information about document numbers at which attributes respectively appear, character positions, number of characters, element name IDs, ancestral path name IDs, and order of branches, using keys consisting of attribute name IDs. With respect to partial character strings extracted from a text within an element and partial character strings extracted from the values of attributes possessed by elements, text appearance information storage portion 114 stores appearing document numbers, character positions, ancestral path name IDs, element name IDs, attribute name IDs, and order of branches together with keys consisting of the partial character strings. In addition, the database apparatus includes search condition input portion 116 accepting search formula 115, search condition analysis portion 117 for analyzing the search formula given to search condition input portion 116, converting the formula into internal conditions, and outputting the conditions to appearance information acquisition portion 118, appearance information acquisition portion 118 for selectively obtaining appropriate information from the four kinds of appearance information stored in appearance position index 110 according to the internal conditions outputted from search condition analysis portion 117 and finding an aggregate of result data matched to the search conditions, and search result output portion 119 for outputting the aggregate of result data as search result 120 in an appropriate form.

The operation of the database apparatus in the present embodiment is described.

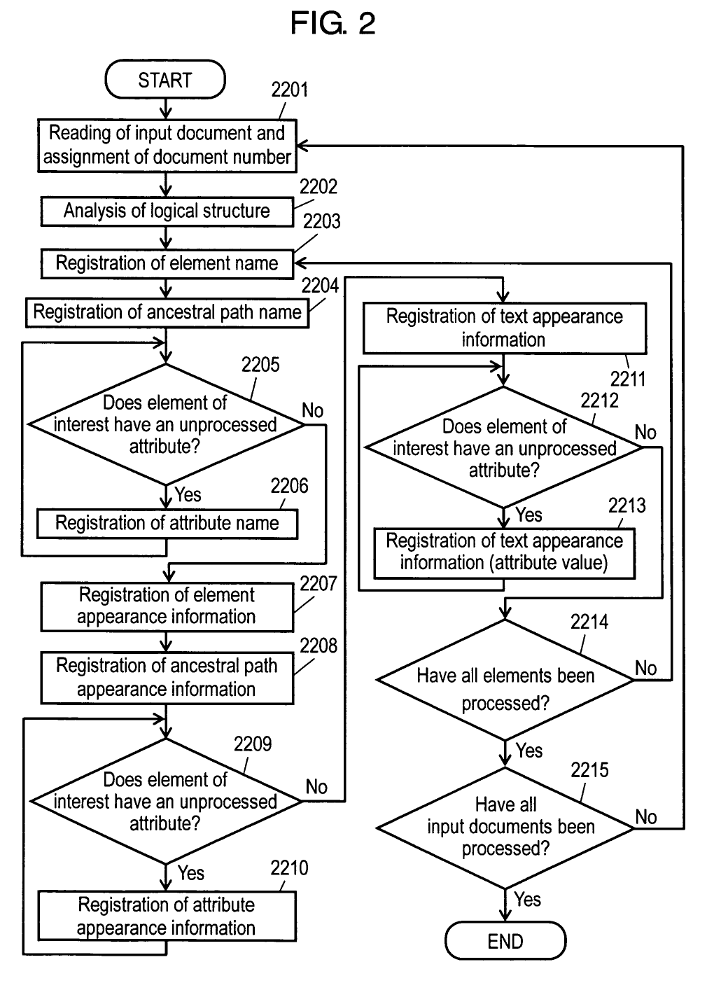

Processing for building a database for registering documents is first described. FIG. 2 is a flowchart illustrating procedures for processing for registration of documents in embodiment 1 of the present invention.

In step 2201, input document analysis portion 102 reads in one structured document from structured documents 101 and assigns a unique document number to each document.

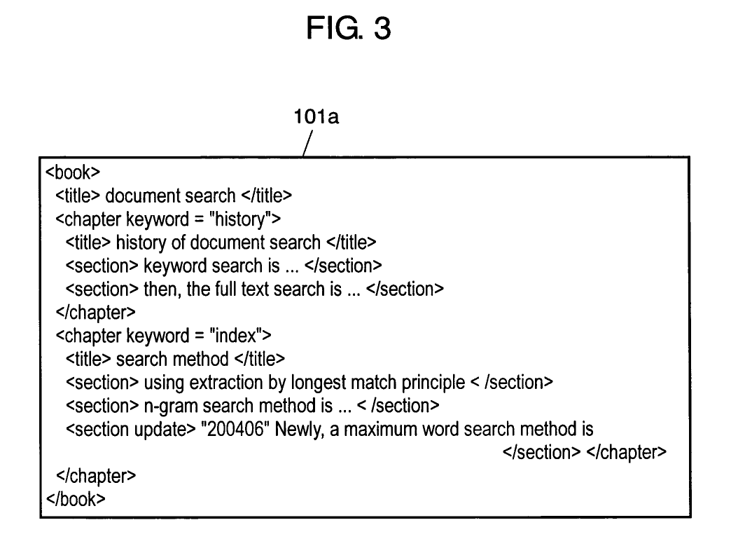

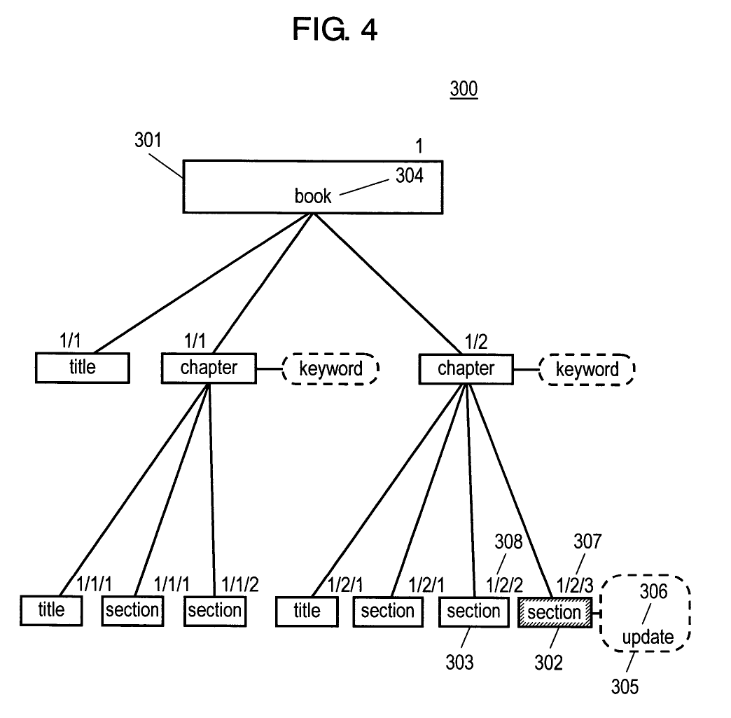

In step 2202, input document analysis portion 102 analyzes the logical structure of the document. FIG. 3 is a diagram illustrating an example of the structured document to be registered and searched in embodiment 1 of the present invention. Structured document 101a shown in FIG. 3 has a book element in the highest level of hierarchy. The book element has a title element and two chapter elements. The title element includes a string of characters “document search” of element entities. The first chapter element has another title element, two section elements, and a keyword attribute having an attribute value of “history”. Results of analysis of structured document 101a into a tree structure done by input document analysis portion 102 are shown in FIG. 4. FIG. 4 is a diagram showing the results of the analysis of the logical structure of a structured document in embodiment 1 of the present invention. In FIG. 4, a rectangular frame of tree structure 300 indicates elements 301 to 303. A string of characters put within the frame indicates element name 304. The elliptical dotted frame indicates attribute 305. A string of characters put within the frame indicates attribute name 306 (update).

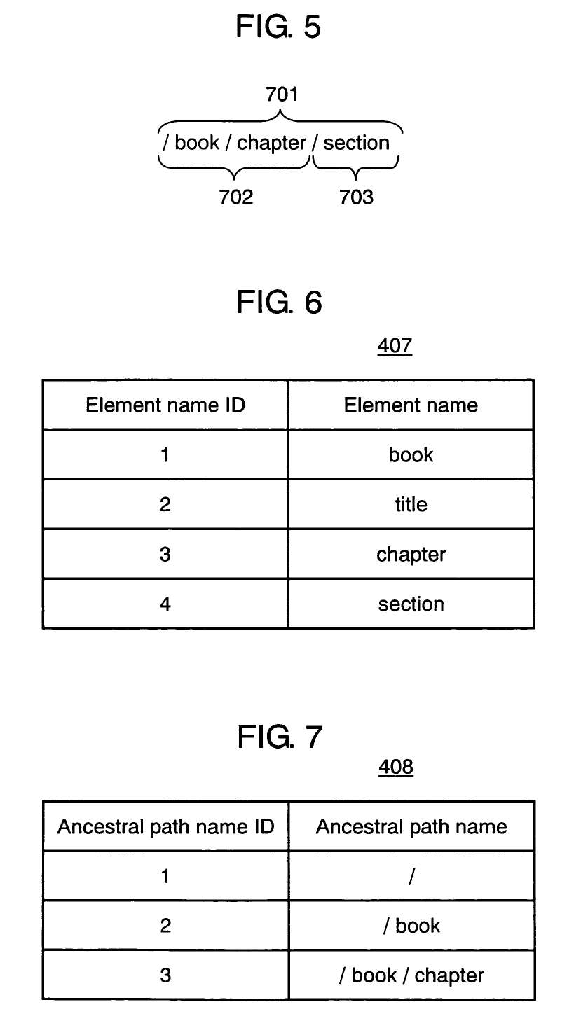

With respect to elements (hereinafter referred to as “ancestral elements”) present in the path going from element 301 at the highest level of hierarchy of tree structure 300 to an element of interest, their names are partitioned by slash marks “/” and arrayed in order. The array is referred to as the “path name”. The end portion of the path name (i.e., the portion excluding the name of the element of interest itself) is referred to as the “ancestral path name”. FIG. 5 is a diagram illustrating the ancestral path name in embodiment 1 of the invention. In FIG. 5, path name 701 of element 302 dot shaded in FIG. 4 is composed of ancestral path name 702 and element name 703.

In FIG. 4, the character string put on the upper right shoulder of each element is referred to as the “order of branches”. For example, order of branches 307 of element 302 is “1/2/3”. The order of branches is an array of numbers each of which indicates the position of appearance of each element within a path name out of elements having the same parent element. In FIG. 4, dot shaded element 302 and element 303 located immediately left of element 302 have the same path name but have different orders of branches 307 and 308, respectively. The method of representing orders of branches is not limited to this. For example, an alternative method is to array the depth of a level of hierarchy having a value other than unity and its value. If expressed by this method, order of branches 307 is “2:2,3:3”. Since the value of depth 1 is “1”, it is omitted. Depth 2 has a value of “2”. Depth 3 has a value of “3”. Where a document where sibling elements with the same element name rarely appear is stored (i.e., almost all of the values of orders of branches are “1”), this method of expression can reduce the size of the appearance position index file.

In step 2203, element name registration portion 103 checks whether the name of an element of interest has been registered in element name dictionary 107. If it has been registered, a corresponding element name ID is acquired. If not so, a new element ID (>0) is assigned, and the element name and element name ID are registered in element name dictionary 107. An example (407) of contents of element name dictionary 107 after structured document 101a shown in FIG. 3 has been registered is shown in FIG. 6.

In step 2204, ancestral path name registration portion 104 checks whether the ancestral path name of an element of interest has been registered in ancestral path name dictionary 108. If it has been registered, a corresponding ancestral path name ID is acquired. If not so, a new ancestral path name ID (>0) is assigned, and the ancestral path name is registered in ancestral path name dictionary 108. An example (408) of the contents of ancestral path name dictionary 108 after structured document 101a shown in FIG. 3 has been registered is shown in FIG. 7.

In step 2205, if an element of interest has an attribute, control goes to step 2206. If not so, control proceeds to step 2207.

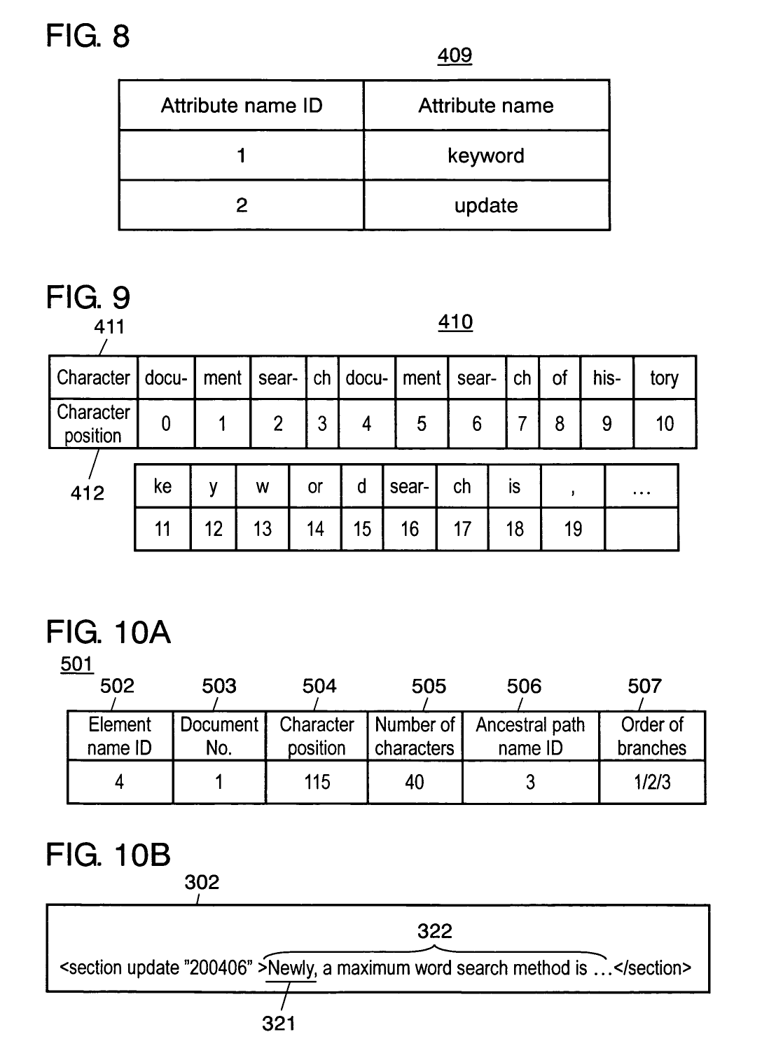

In step 2206, attribute name registration portion 105 checks whether the attribute name of each attribute of the element of interest has been registered in attribute name dictionary 109. If it has been registered, a corresponding attribute name ID is acquired. If not so, a new attribute name ID (>0) is assigned. The attribute name is registered in attribute name dictionary 109. An example (409) of the contents of attribute name dictionary 109 after the structured document 101a shown in FIG. 3 has been registered is shown in FIG. 8.

In step 2207, appearance information registration portion 106 registers information about the appearance of an element of interest in element appearance information storage portion 111 using the element name ID as a key. Element appearance information is made up of sets of the values of the following five kinds: document number, the position of the initial character and the number of characters of a text (including ancestral elements and excluding the tag) contained in the element of interest, ancestral path name ID, and order of branches. FIG. 9 is a diagram illustrating the manner in which character positions are counted in the database apparatus in the present embodiment. In FIG. 9, table 410 indicates the position 412 of each character 411 in a string of characters obtained by connecting all the texts within this document excluding tags. The forefront character position is assumed to be “0”. FIGS. 10A-10B are diagrams illustrating information about appearance of elements in embodiment 1 of the present invention. In FIG. 10B, with respect to element entity 304 of section element 302 dot shaded in FIG. 4, the position of initial character 321 is “115”. The number of characters of whole element entity 322 is “40”. Information 501 about the appearance of the elements regarding section element 302 is shown in FIG. 10A. In FIG. 10A, element name ID (502) of section element 302 is “4”. Document number (503) is “1”. Section element 302 includes element entities of characters (the number of characters is 505) having a length “40” starting with the 115th character (character position 504). Ancestral path name ID (506) of section element 302 is “3”, and the order of branches (507) is “1/2/3”. The ancestral path name having an ancestral path name ID 506 of “3” is “/book/chapter”.

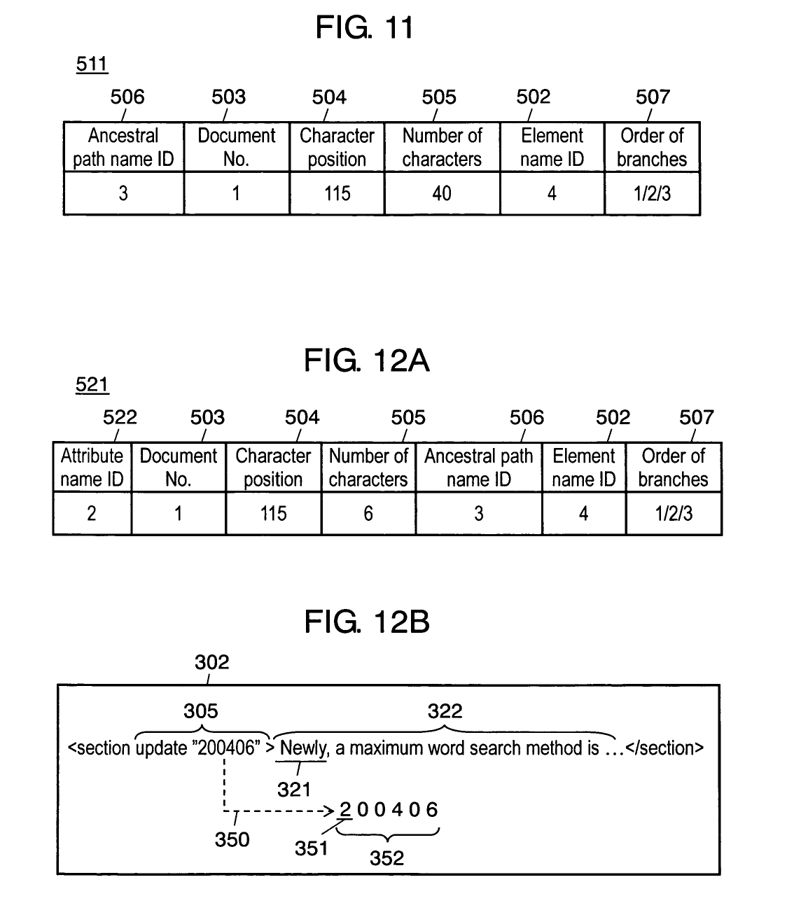

In step 2208, appearance information registration portion 106 registers ancestral path appearance information about the element of interest in ancestral path appearance information storage portion 112 using ancestral path name ID as a key. The ancestral path appearance information is made up of sets of values of the following five kinds: document number, the position of the initial character and the number of characters of a text (including descendant elements and excluding the tag) contained in the element of interest, element name ID, and the order of branches. FIG. 11 is a diagram illustrating the ancestral path appearance information in embodiment 1 of the present invention. In FIG. 11, contents 511 of the ancestral path appearance information regarding dot shaded element 302 in FIG. 4 are shown. As shown in FIGS. 10A and 11, the element appearance information and the ancestral path appearance information about the same element are different only in that the item acting as a key is element name ID 502 or ancestral path name ID 506.

In step 2209, if the element of interest has an attribute, control goes to step 2210. If not so, control goes to step 2211.

In step 2210, appearance information registration portion 106 registers attribute appearance information regarding attributes of the element of interest in attribute appearance information storage portion 113 using attribute name ID as a key. The attribute appearance information is made up of sets of values of the following six kinds: document number, the position of the initial character and the number of characters of an attribute value, ancestral path name ID, element name ID, and the order of branches. FIGS. 12A-12B are diagrams illustrating attribute appearance information in embodiment 1 of the invention. In FIG. 12B, section element 302 dot shaded in FIG. 4 includes update attribute 305. With respect to attribute value 350 of update attribute 305, position 351 of initial character 351 is “115”. The number of characters 352 of whole attribute value 305 is “6”. It is assumed that the position of the initial character of the attribute value in the attribute appearance information has the same value as the position of first character 321 of the text (excluding tags) virtually contained in element 322 (also including descendant elements) of interest as shown in FIG. 12B. Attribute appearance information 521 regarding update attribute 305 of section element 302 is shown in FIG. 12A. In FIG. 12A, attribute name ID (522) is “2” and the document number (503) is “1”. Update attribute 305 has an attribute value of characters having length “6” (number of characters is 505) beginning with the 115th character (character position 504). Ancestral path name ID (506) of the element to which update attribute 305 belongs is “3”. Element ID (502) is “4”. Order of branches (507) is “1/2/3”. The attribute name having attribute name ID of “2” is “update”. The ancestral path name having ancestral path name ID 506 of “3” is “/book/section”. The name of an element having element name ID 502 of “4” is “section”.

In step 2211, appearance information registration portion 106 extracts a partial character string from the text of the contents of the entity of the element of interest. The text appearance information is registered in text appearance information storage portion 114 using the extracted partial character string as a key. At this time, for discrimination with the attribute value, 0 is always stored in attribute name ID. The text appearance information is made up of sets of the values of the following six kinds: document name, position of the initial character of the extracted partial character string, ancestral path name ID, element name ID, attribute name ID, and order of branches.

In step 2212, if the element of interest has an attribute, control goes to step 2213. If not so, control goes to step 2214.

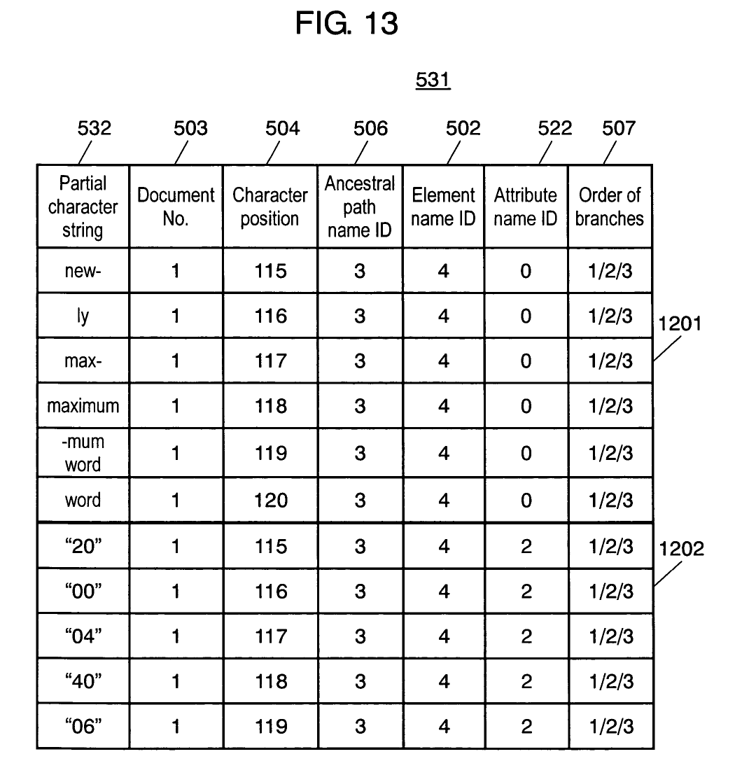

In step 2213, appearance information registration portion 106 extracts a partial character string from the character string of attribute values of each attribute possessed by the element of interest, and registers the extracted string in text appearance information storage portion 114 using the partial character string as a key. Assuming that the attribute values virtually appear in the positions shown in FIG. 11, character positions are computed in the same way as in attribute appearance information. In step 2213, the attribute name ID (>0) of the attribute of interest is stored in the attribute name ID, unlike in processing in step 2211. FIG. 13 is a diagram illustrating the text appearance information in embodiment 1 of the present invention. In FIG. 13, (partial) text appearance information 531 includes element entity (text) of section element 302 dot shaded in FIG. 4 and text appearance information about the attribute value of update attribute 305 of section element 302. Appearance information record 1201 shows an example of the element entity of section element 302. Partial character string (532) “maximum” of the element entity of section element 302 appears at the 118th character (character position 504) of a document having a document number (503) of “1”. The ancestral path name ID (506) of the element contained in the partial character string, i.e., section element 302, is “3”. Element name ID (502) is “4”. The order of branches (507) is “1/2/3”. The ancestral path name having an ancestral path name ID 506 of 3 is “/book/section”. The element name having an element name ID 502 of 4 is “chapter”. It is possible to make a decision as to whether or not partial character string 532 is an attribute value, depending on attribute name ID 522. It is assumed that if the attribute name ID is “0”, partial character string 532 is judged to be an attribute value. Appearance information record 1202 shows an example of attribute value of update attribute 305 in section element 302. Partial character string (532) “00” of the attribute value of update attribute 305 appears at the 116th character (character position 504) of a document having a document number (503) of “1”. The element of the attribute containing the partial character string, i.e., ancestral path name ID of section element 302, is “3”. Element name ID (502) is “4”. The order of branches (507) is “1/2/3”. The attribute name ID (522) to which the element belongs is “2”. The ancestral path name having an ancestral path name ID of “3” is “/book/section”. The element name having an element name ID of “4” is “chapter”. The attribute name having an attribute name ID of “2” is “update”.

In step 2214, a check is performed to see whether processing has been completed for every element appearing in the document. If there is any unprocessed element, control returns to step 2203, and the processing is repeated.

In step 2215, a check is performed as to whether processing for all the input documents has been completed. If there is any unprocessed document, control returns to step 2201, and the processing is repeated.

As described so far, the database apparatus in the present embodiment registers documents and completes the processing for building a database.

Processing performed by the database apparatus in the present embodiment to search documents already registered is next described.

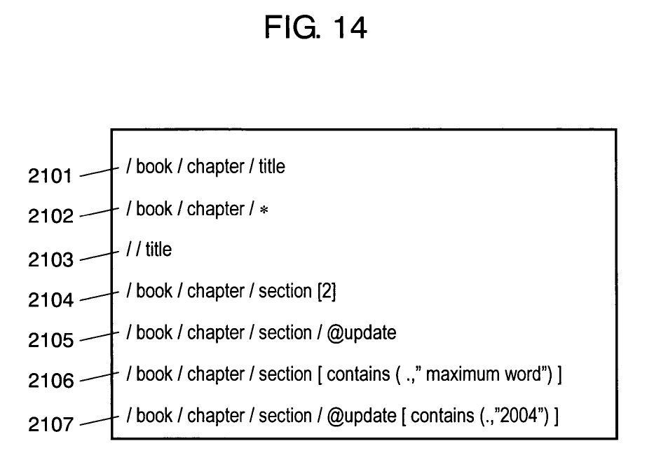

FIG. 14 is a diagram illustrating examples of search formulas in embodiment 1 of the present invention. These search formulas 2101 to 2107 are written in the Xpath language disclosed as recommendations of W3C (World Wide Web Consortium). Detailed specifications of the Xpath language are described at URL <http://www.w3.org/TR/xpath >.

Search equation 2101 indicates a “title element that is a child of a chapter element which is a child of a book element at the highest level of hierarchy”. Search equation 2102 indicates “any child element of a chapter element that is a child of a book element at the highest level of hierarchy”. Search equation 2103 indicates a “title element at some level of hierarchy ”. Search equation 2104 indicates the “second section element of a child of a chapter element that is a child of a book element at the highest level of hierarchy”. Search formula 2105 indicates an “update attribute of a section element of a child of a chapter element of a child that is a book element at the highest level of hierarchy”. Search equation 2106 indicates a “section element of a child of a chapter element that is a child of a book element at the highest level of hierarchy, the section element including a character string “maximum word” in the contents of the element entity”. Search formula 2107 indicates an “update attribute of a section element of a child of a chapter element that is a child of a book element at the highest level of hierarchy, the update attribute including a character string “2004” at its attribute value”.

The operations of the database apparatus in the present embodiment for performing searching using the search equations are next described in succession.

(In the Case of Search Equation 2101)

The operation in the case where search formula 2101 is given as a search condition is first described.

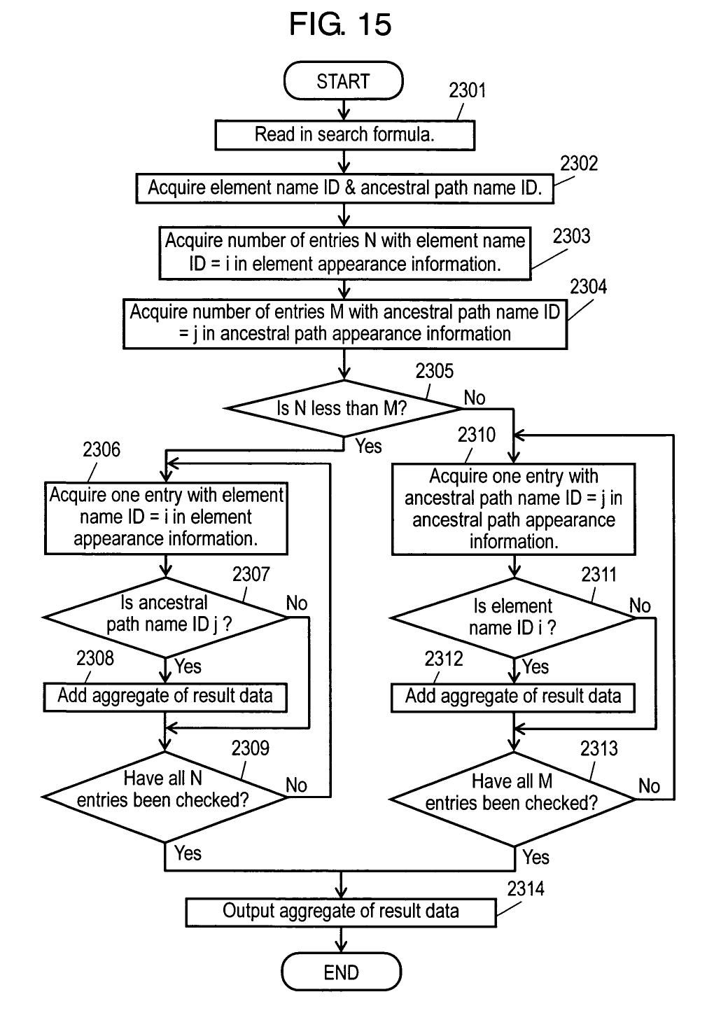

FIG. 15 is a flowchart illustrating procedures of the database apparatus in embodiment 1 of the present invention to perform a search.

In step 2301, search condition input portion 116 enters search formula 2101.

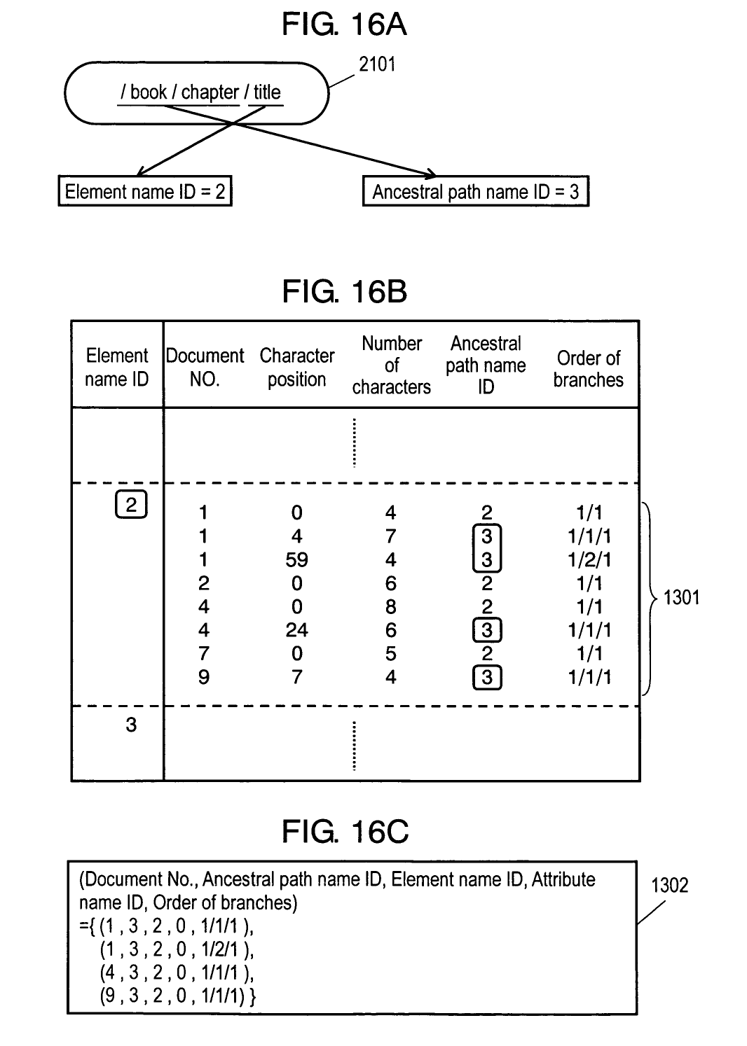

In step 2302, search condition analysis portion 117 analyzes entered search formula 2101 and converts it into internal conditions “ancestral path name ID=3 and element name ID=2” by referring to element name dictionary 107 and ancestral path name dictionary 108 as shown in FIG. 16A. The results are output to appearance information acquisition portion 118.

In step 2303, appearance information acquisition portion 118 refers to appearance position index 110 and acquires the number of entries N of element name ID=2 in element appearance information storage portion 111.

In step 2304, appearance information acquisition portion 118 refers to appearance position index 110 and acquires the number of entries M of ancestral path name ID=3 in ancestral path appearance information storage portion 112.

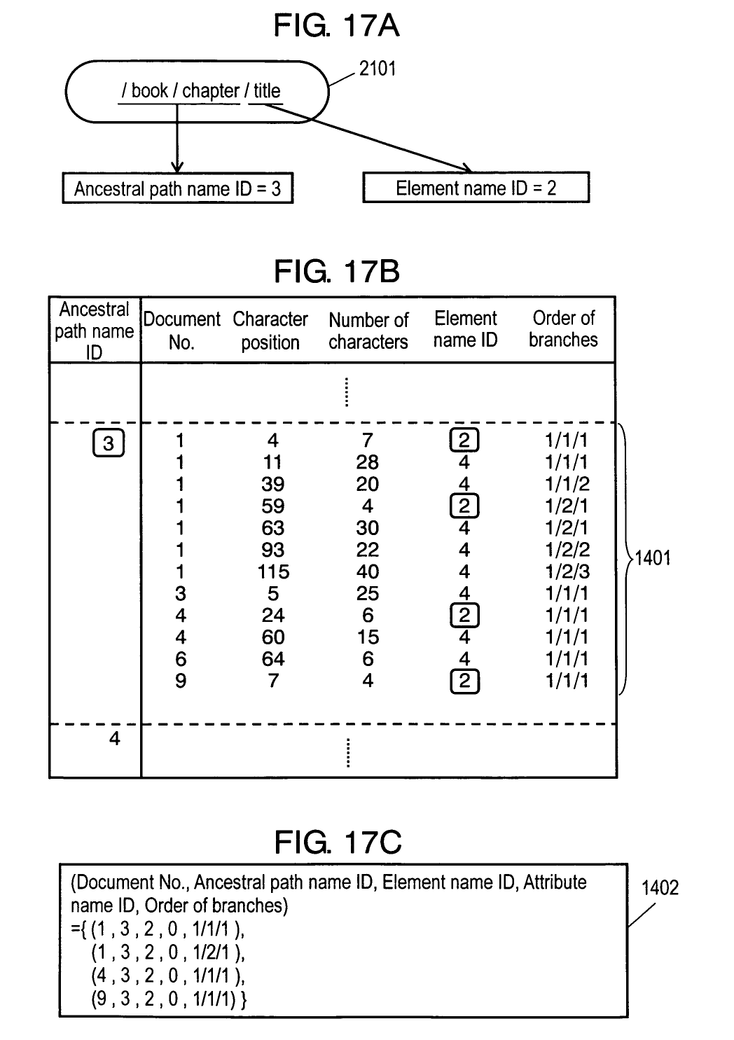

In step 2305, appearance information acquisition portion 118 compares the acquired number of entries N with the number of entries M. If N<M, control goes to step 2306. If not so, control proceeds to step 2310. FIG. 16B shows an example of entry 1301 of element name ID=2 in element appearance information storage portion 111. FIG. 17B shows an example of entry 1401 of ancestral path name ID=3 in ancestral path appearance information storage portion 112. In the example shown in FIG. 16A, N=8 and M=12. In this case, N<M. Control goes to step 2306. Element appearance information storage portion 111 of FIG. 16B is selected.

In step 2306, appearance information acquisition portion 118 acquires one from entries 1301 of element name ID=2 in element appearance information storage portion 111.

In step 2307, appearance information acquisition portion 118 checks whether or not the ancestral path name ID of this entry is 3. If the ancestral path name ID is 3, control goes to step 2308. If not so, control goes to step 2309.

In step 2308, appearance information acquisition portion 118 adds data about this entry to an aggregate of data about results 1302. The aggregate of data about the results is shown in FIG. 16C. Each data item of the aggregate of result data 1302 is stored, for example, in the form (document number, ancestral path name ID, element name ID, attribute name ID, and order of branches).

In step 2309, appearance information acquisition portion 118 checks whether all of N entries have been processed. If there is any unprocessed entry, control returns to step 2306, where the processing is repeated.

In step 2305, if appearance information acquisition portion 118 judges that N<M does not hold, control goes to step 2310. Appearance information acquisition portion 118 checks each entry 1401 of ancestral path name ID=3 in ancestral path appearance information storage portion 112 as shown in FIG. 17B. Appearance information acquisition portion 118 finds ones having an element name ID of 2. These are added to aggregate of data about results 1402 as shown in FIG. 17C (steps 2310 to 2313).

In step 2314, appearance information acquisition portion 118 outputs the found aggregate of data about the results to search result output portion 119. Search result output portion 119 outputs the results of the search in an appropriate form, for example, by acquiring the document entities of the found aggregate of data about results.

In this way, the database apparatus in the present embodiment selects one with a less number of entries from first processing and second processing concerning search formula 2101. In the first processing, one having a specified ancestral path name ID is selected from entries of specified element name IDs in element appearance information storage portion 111. In the second processing, an entry having the specified element name ID is selected from entries of the specified ancestral path name IDs in ancestral path appearance information storage portion 112. Therefore, the amount of processing can be suppressed according to the characteristics of the logical structure of structured documents to be searched. Desired documents can be efficiently searched.

(In the Case of Search Formula 2102)

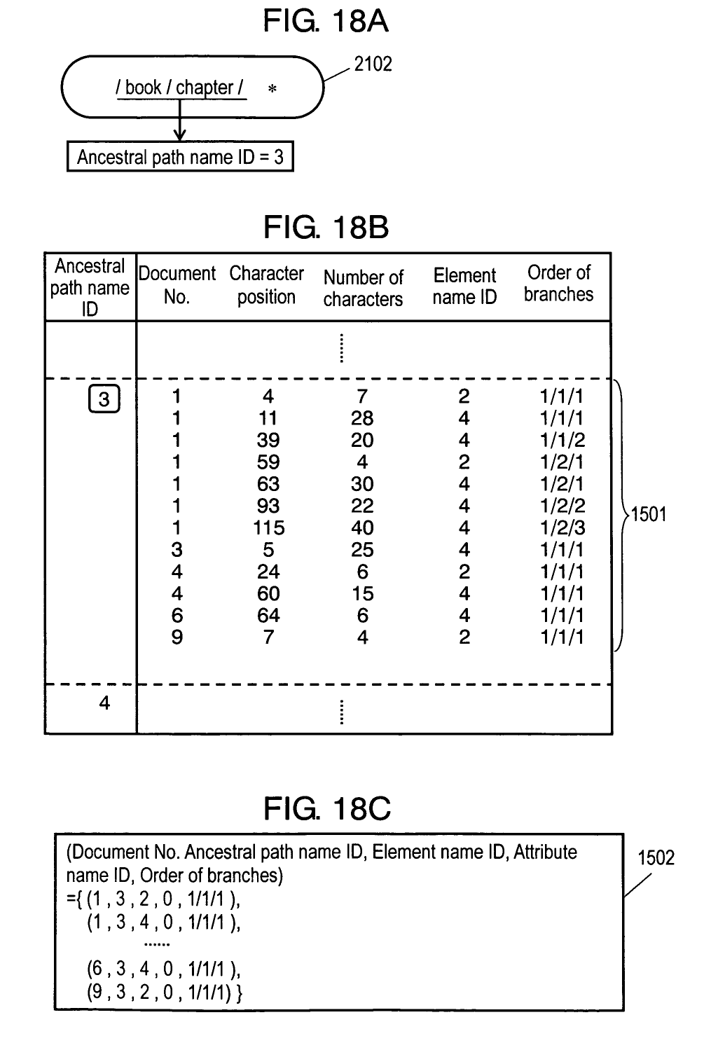

The operation in the case where search formula 2102 is entered into search condition input portion 116 is described next. Search condition analysis portion 117 analyzes search formula 2102 as shown in FIG. 18A, refers to ancestral path name dictionary 108, and converts it into an internal condition “ancestral path name ID=3”. The results are output to appearance information acquisition portion 118. Appearance information acquisition portion 118 refers to appearance position index 110 and finds all entries 1501 with ancestral path name ID=3 in ancestral path appearance information storage portion 112 as shown in FIG. 18B. They are output as an aggregate of data about results 1502 in the form, for example, (document number, ancestral path name ID, element name ID, attribute name ID, and order of branches) to search result output portion 119 as shown in FIG. 18C. Search result output portion 119 outputs the results of the search in an appropriate form, for example, by acquiring document entities of the found result data aggregate 1502.

In this manner, the database apparatus in the present embodiment is only required to obtain entries of the specified ancestral path name ID in ancestral path appearance information storage portion 112 for search formula 2102. Hence, desired documents can be efficiently searched.

(In the Case of Search Formula 2103)

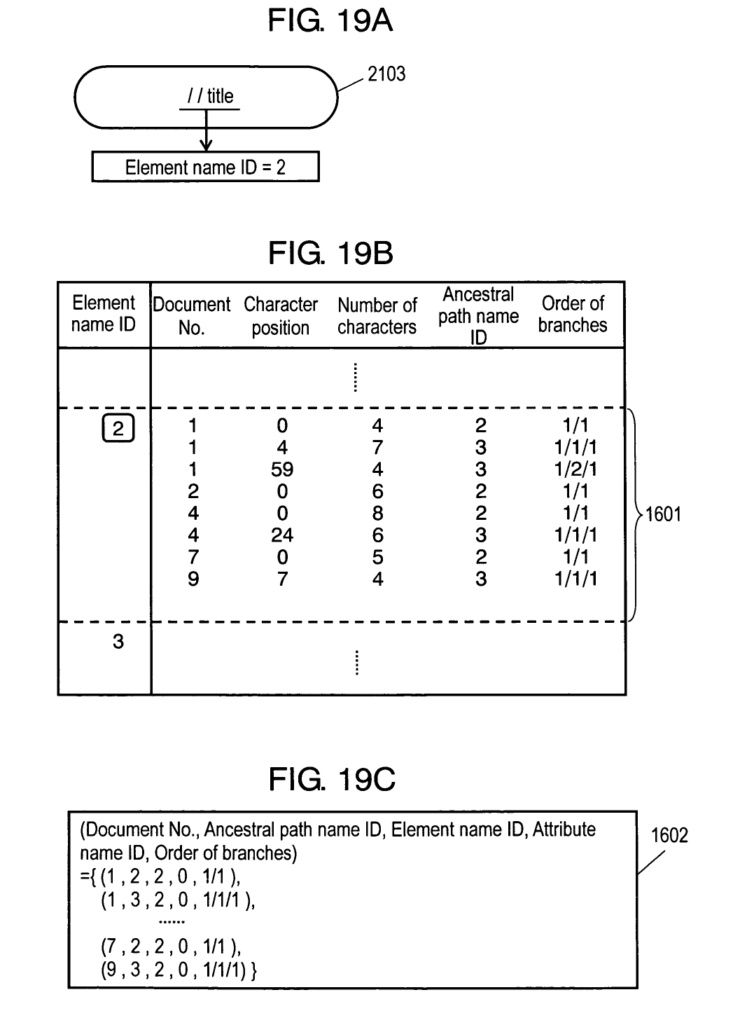

The operation in the case where search formula 2103 is entered into search condition input portion 116 is next described. Search condition analysis portion 117 analyzes search formula 2103 as shown in FIG. 19A and converts it into an internal condition “element name ID=2” while referring to element name dictionary 107. The results are output to appearance information acquisition portion 118. Appearance information acquisition portion 118 refers to appearance position index 110 and finds all entries 1601 with element name ID=2 in element appearance information storage portion 111 as shown in FIG. 19B. The acquisition portion then outputs result data aggregate 1602, for example, in the form (document number, ancestral path name ID, element name ID, attribute name ID, order of branches) to search result output portion 119 as shown in FIG. 19C. Search result output portion 119 outputs the results of the search in an appropriate form, for example, by acquiring document entities of the found result data aggregate 1602.

In this way, the database apparatus in the present embodiment is only required to obtain the entries of the specified element name IDs in element appearance information storage portion 111 for search formula 2103 and so it can efficiently search desired documents.

(In the Case of Search Formula 2104)

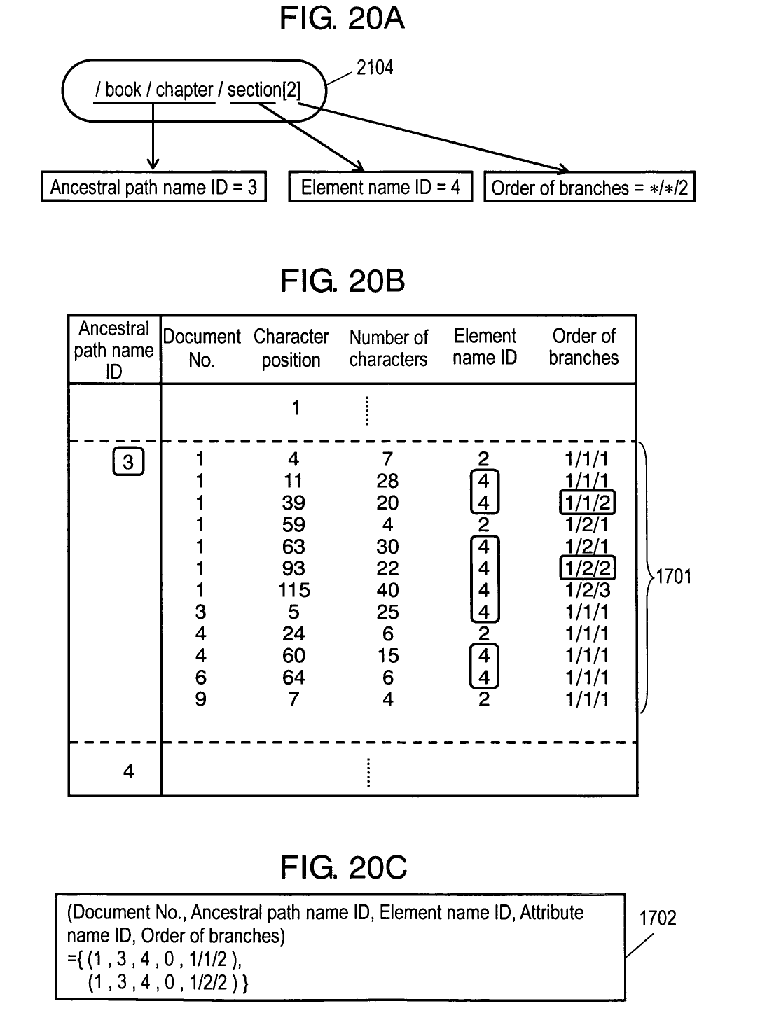

The operation in the case where search formula 2104 is entered into search condition input portion 116 is next described. Search condition analysis portion 117 analyzes search formula 2104 as shown in FIG. 20A and converts it into internal conditions “ancestral path name ID=3 and element name ID=4 and order of branches=*/*/2” while referring to element name dictionary 107 and ancestral path name dictionary 108. The results are output to appearance information acquisition portion 118. The asterisk * portions of the order of branches indicate that any number can be matched. Appearance information acquisition portion 118 refers to appearance position index 110 and finds the number of entries N with element name ID=4 in element appearance information storage portion 111 and the number of entries M with ancestral path name ID=3 in ancestral path appearance information storage portion 112. The acquisition portion compares the numbers of entries N and M and selects a smaller one. Each entry 1701 with ancestral path name ID=3 in ancestral path appearance information storage portion 112 is checked as shown in FIG. 20B unless N<M. Data about an entry having an element name ID of 4 and an order of branches of “*/*/2” is found. The found data is output as result data aggregate 1702, for example, in the form (document number, ancestral path name ID, element name ID, attribute name ID, and order of branches) to search result output portion 119 as shown in FIG. 20C. If N<M, each entry with element name ID=4 in element appearance information storage portion 111 (not shown) is checked. Data about an entry having an ancestral path name ID of 3 and an order of branches of “*/*/2” is found. The found data is output as result data aggregate 1702 to search result output portion 119. Search result output portion 119 outputs the results of the search in an appropriate form, for example, by gaining document entities of the found result data aggregate.

In this way, the database apparatus in the present embodiment selects one with a less number of entries from first processing and second processing concerning search formula 2104. In the first processing, one having specified ancestral path name ID and order of branches is selected from entries of the specified element name ID in element appearance information storage portion 111. In the second processing, an entry having the specified element name ID and order of branches is selected from entries of the specified ancestral path name IDs in ancestral path appearance information storage portion 112. Consequently, the amount of processing for searching can be reduced. Desired documents can be efficiently searched.

(In the Case of Search Formula 2105)

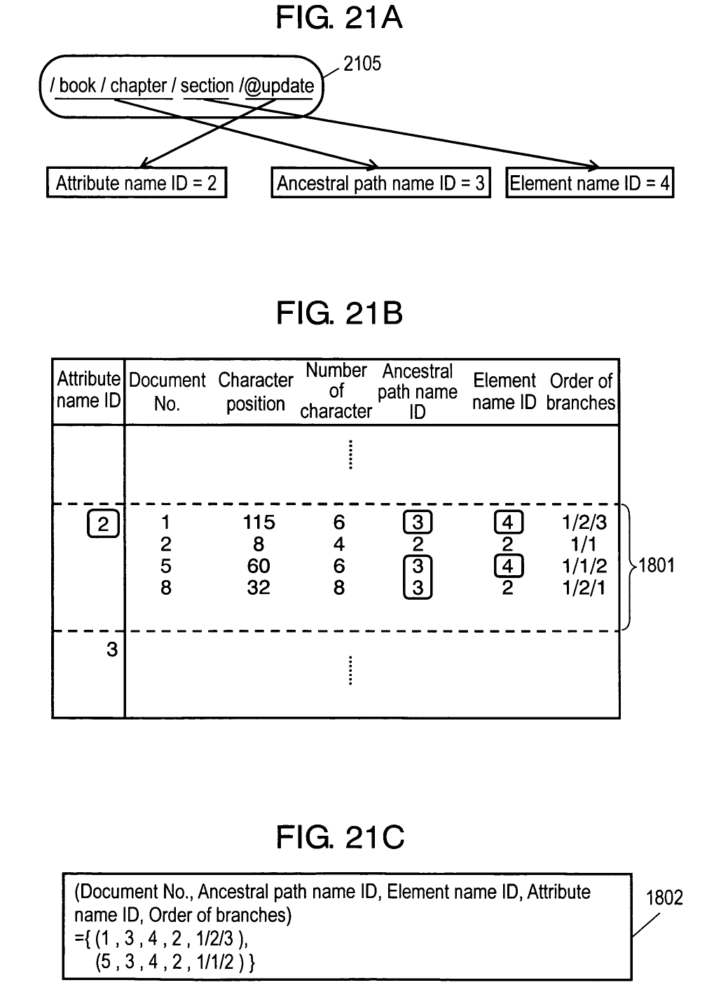

The operation in the case where search formula 2105 is entered into search condition input portion 116 is next described. Search condition analysis portion 117 analyzes search formula 2105 as shown in FIG. 21A and converts it into the internal conditions “ancestral path name ID=3 and element name ID=4 and attribute name ID=2” while referring to element name dictionary 107, ancestral path name dictionary 108, and attribute name dictionary 109. The results are output to appearance information acquisition portion 118. Appearance information acquisition portion 118 refers to appearance position index 110 and checks each entry 1801 with attribute name ID=2 in attribute appearance information storage portion 113 as shown in FIG. 21B. The portion finds data about an entry having an ancestral path name ID of 3 and an element name ID of 4. Appearance information acquisition portion 118 outputs the found data as result data aggregate 1802, for example, in the form (document number, ancestral path name ID, element name ID, attribute name ID, and order of branches) as shown in FIG. 21C to search result output portion 119. Search result output portion 119 outputs the result of the search in an appropriate form, for example, by obtaining document entities of the found result data aggregate.

In this way, the database apparatus in the present embodiment selects an entry having the specified ancestral path name ID and element name ID from entries with the specified attribute name ID in attribute appearance information storage portion 113 regarding search formula 2105. Desired documents can be searched.

(In the Case of Search Formula 2106)

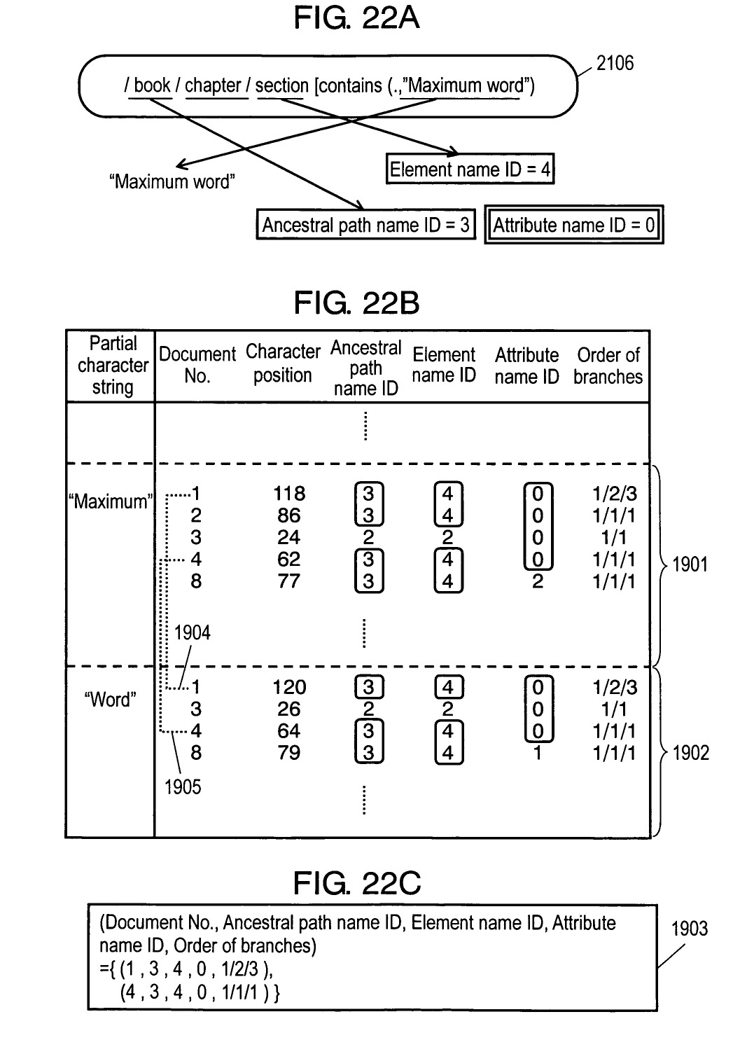

The operation in the case where search formula 2106 is entered into search condition input portion 116 is next described. Search condition analysis portion 117 analyzes search formula 2106 and converts it into internal conditions “ancestral path name ID=3 and element name ID=4 and inclusion of a character string “maximum word” within the element” while referring to element name dictionary 107 and ancestral path name dictionary 108 as shown in FIG. 22A. The results are output to appearance information acquisition portion 118. Appearance information acquisition portion 118 refers to appearance position index 110 and computationally concatenates together entry 1901 of “maximum” in text appearance information storage portion 114 and entry 1902 of “word” as shown in FIG. 22B. At this time, checks are made whether the ancestral path name ID is 3, whether the element name ID is 4, whether the attribute name ID is 0, and whether the order of branches is identical, as well as whether the document number is identical and whether “word” is located two characters behind “maximum”. Thus, an entry satisfying the conditions is found. Appearance information acquisition portion 118 outputs the found entry as result data aggregate 1903, for example, in the form (document number, ancestral path name ID, element name ID, attribute name ID, and order of branches) to search result output portion 119 as shown in FIG. 22C. Search result output portion 119 outputs the result of the search in an appropriate form, for example, by acquiring the document entities of the found result data aggregate.

In this way, the database apparatus in the present embodiment selects ones (1904 and 1905) which have specified values of ancestral path name ID and element name ID, are identical in order of branches, and have an attribute name ID of 0 when entries of partial character strings in text appearance information storage portion 114 are computationally concatenated together for search formula 2106. It is possible to search desired documents.

(In the Case of Search Formula 2107)

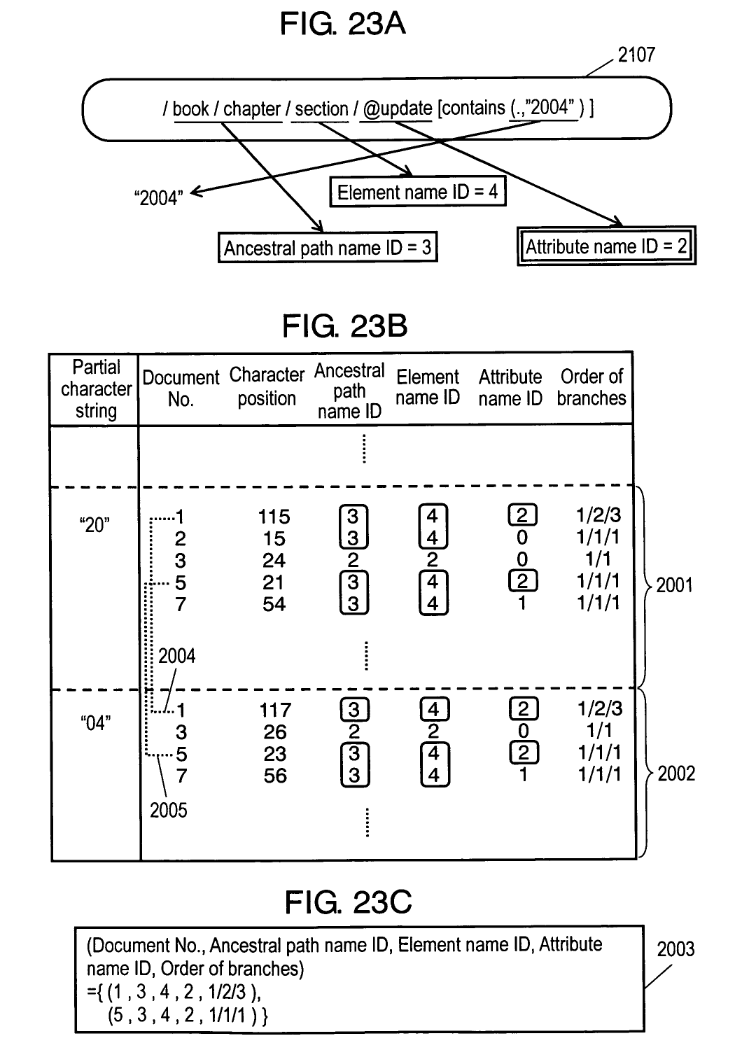

The operation in the case where search formula 2107 is entered into search condition input portion 116 is next described. Search condition analysis portion 117 analyzes search formula 2107 and converts it into internal conditions “ancestral path name ID=3, element name ID=4, attribute name ID=2, and attribute value having a character string “2004”” while referring to element name dictionary 107, ancestral path name dictionary 108, and attribute name dictionary 109 as shown in FIG. 23A. The results are output to appearance information acquisition portion 118. Appearance information acquisition portion 118 refers to appearance position index 110 and computationally concatenates together entry 2001 of “20” in text appearance information storage portion 114 and entry 2002 of “04” as shown in FIG. 23B. At this time, appearance information acquisition portion 118 make checks whether the ancestral path name ID is 3, whether the element name ID is 4, whether the attribute name ID is 2, and whether the order of branches is identical, as well as whether the document number is identical and whether “20” is located two characters behind “04”. Thus, an entry satisfying the conditions is found. Appearance information acquisition portion 118 outputs the found entry as result data aggregate 2003, for example, in the form (document number, ancestral path name ID, element name ID, attribute name ID, and order of branches) to search result output portion 119 as shown in FIG. 23C. Search result output portion 119 outputs the result of the search in an appropriate form, for example, by acquiring the document entities of the found result data aggregate.

In this way, the database apparatus in the present embodiment selects ones (2004 and 2005) which have specified values of ancestral path name ID and element name ID, are identical in order of branches, and have a specified value of attribute name ID (>0) when entries of partial character strings in text appearance information storage portion 114 are computationally concatenated together for search formula 2107. It is possible to search desired documents.

As described so far, the database apparatus in the present embodiment has the element appearance information storage portion in which information about appearance of elements is stored using element name IDs as keys, the ancestral path appearance information storage portion in which the information about the appearance of the elements is stored using ancestral path name IDs of the elements as keys, and the attribute appearance information storage portion in which information about the appearance of attributes are stored using attribute name IDs as keys. Therefore, the database apparatus can search desired documents efficiently even using a search formula that specifies only structural conditions.

The database apparatus in the present embodiment further includes the text appearance information storage portion in which information about appearance of a text character string of element entities and a partial character string extracted from attribute values of attributes possessed by the elements are stored. Therefore, the database apparatus can search character strings even for attribute values as well as for texts of element entities.

In the description provided so far, the database apparatus in the present embodiment extracts a partial character string from element entities or attribute values in the processing for building a database such that 2 characters of fixed length are concatenated together. However, other method of extraction such as a method described, for example, in Japanese Patent Unexamined Publication No. H8-249354, entitled “Document Search Apparatus, Method of Creating Index for Words, and Method of Searching Documents”, may also be used.

Furthermore, in the description of the database apparatus in the present embodiment provided so far, search conditions are given in XPath expressions in processing for searching a database. The present invention can also be applied even if they are given in other query language expressing the same meaning.

In this way, in the database apparatus in the present embodiment, when structured documents are registered, a list of element names showing the document structure contained in the structured document, ancestral path names, and attribute names and index about information indicating the positions at which they appear in the structured documents are created. Therefore, the database apparatus can build a database permitting efficient search of documents having a desired logical structure if various search conditions specifying only structures are given, as well as if search conditions specifying character string search conditions and structural conditions are both given.

In addition, character strings can be searched by attribute values, as well as by text character strings of element entities.

In the database apparatus in the present embodiment, when a structured document is registered, first and second configurations are achieved at the same time. In the first configuration, a document structure is analyzed to build dictionary data and appearance position index data. Then, the structured document is registered. In the second configuration, with respect to documents given by search formulas showing the accepted document structure, registered documents are efficiently searched based on the dictionary data and on the appearance position index data. Alternatively, a configuration having only a registering function may be realized as a database building apparatus or a configuration having only a searching function may be realized as a database search apparatus.

In the database apparatus in the present embodiment, when a structured document is registered, first, second, and third configurations are achieved at the same time. In the first configuration, dictionary data about elements and ancestral paths and appearance position index data are created and registered. In the second configuration, dictionary data about the attributes and appearance position index data are created and registered in the first configuration. In the third configuration, appearance position index data about text of elements and attribute values are created and registered in the second configuration. In a fourth configuration, only elements and ancestral paths may be registered. In a fifth configuration, attributes may be registered in addition to the fourth configuration. In a sixth configuration, texts may be registered in addition to the fifth configuration.

### Embodiment 2

The configuration and operation of a database apparatus in the present embodiment 2 are next described. The database apparatus in the present embodiment is similar to embodiment 1 shown in FIG. 1 except for the following points. In this database apparatus, ancestral path name registration portion 104 divides an ancestral path name into partial ancestral path names and assigning a unique ancestral path name ID to each partial ancestral path name instead of ancestral path names appearing in documents. Then, the path names are registered in ancestral path name dictionary 108. In the database apparatus, appearance information registration portion 106 stores information about document numbers at which elements appear, character positions, number of characters, a string of ancestral path name IDs, order of branches, and order of empty elements in element appearance information storage portion 111, using element name IDs as keys. The database apparatus stores information about document numbers at which elements appear, character positions, the number of characters, element name IDs, order of branches, and order of empty elements in ancestral path appearance information storage portion 112, using a string of ancestral path name IDs as a key. The database apparatus stores information about document numbers at which attributes appear, character positions, the number of characters, element name IDs, ancestral path name ID strings, order of branches, and order of empty elements in attribute appearance information storage portion 113 using attribute name IDs as keys. The database apparatus stores information about appearing document numbers, character positions, ancestral path name ID strings, element name IDs, attribute name IDs, order of branches, and order of empty elements in text appearance information storage portion 114 using partial character strings as keys regarding the partial character strings extracted from texts within elements and partial character strings extracted from the values of attributes possessed by elements.

The operation of the processing performed by the database apparatus in the present embodiment to register documents and build a database is described by referring to FIG. 2. Description of the same processing as embodiment 1 is omitted.

In step 2201, input document analysis portion 102 reads in one structured document and assigns a unique document number to it.

In step 2202, the logical structure of this structured document is analyzed. At this time, processing for finding information about “order of empty elements” regarding each element is added to the processing of embodiment 1. The “empty element” referred to herein is an element having no text of an element entity at all; the element can be a descendant element. The “order of empty elements” is an array of the following values found at various levels of hierarchy from the highest level to this element. 1 is added to the order of empty elements in a case where the element is either the forefront one of sibling elements having the same parent element or an element whose immediately preceding sibling element is not an empty element. In the other cases (i.e., the immediately preceding sibling element is an empty element), 1 is added to the value of the order of the empty elements.

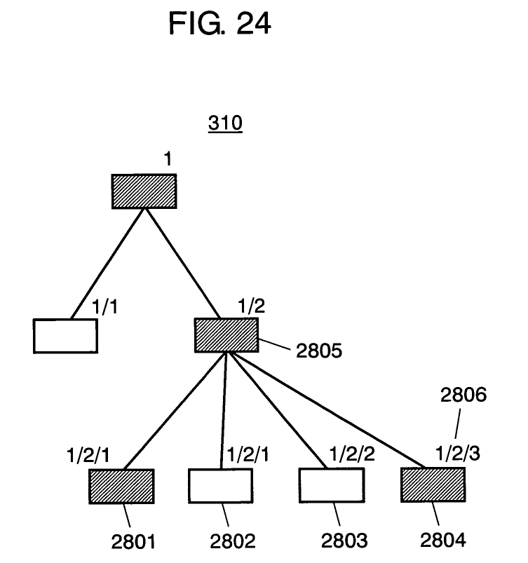

FIG. 24 is a diagram illustrating the order of empty elements in embodiment 2 of the present invention. In FIG. 24, an example of tree structure 310 of a document and the order of empty elements is shown. Hatched rectangular frames indicate elements 2801, 2804, and 2805 including texts of element entities. Plain rectangular frames indicate empty elements 2802 and 2803 containing no element entity. Strings of characters put in the form “1/2/3” at the right shoulder of each element indicates information about the order of empty elements 2806 of each element.

The first two numerals “½” indicated by the order of empty elements of sibling elements 2801 to 2804 are the orders of empty elements of ancestral elements. These are common among sibling elements. The terminal numeral n varies with each different sibling element. Element 2801 is the forefront element of sibling elements and so n=1. With respect to element 2802, the immediately preceding element 2801 is not an empty element and so n=1. With respect to element 2803, the immediately preceding element 2802 is an empty element and so 1 is further added. Thus, n=2. With respect to element 2804, the immediately preceding element 2803 is an empty element and so 1 is further added. Thus, n=3. Accordingly, the orders of empty elements of sibling elements 2801 to 2804 are “1/2/1”, “1/2/1”, “1/2/2”, and “1/2/3”, respectively.

The method of expressing each order of empty elements is not limited to this. For example, a method of consisting of arraying the depths of hierarchical levels having values other than unity and their values and expressing the array may also be adopted. If the order of empty elements 2806 “1/2/3” is expressed by this method, we have “2:2, 3:3”. The value of depth 1 is “1” and so this is omitted. The value of depth 2 is “2”. The value of depth 3 is “3”. Therefore, where a document in which almost no empty elements appear (i.e., a document having the values of the orders of empty elements of nearly “1”) is treated, the latter method of expression can better reduce the size of the appearance position index file.

In step 2203, element name registration portion 103 performs processing for registering the element names of elements of interest in element name dictionary 107 in the same way as in embodiment 1.

In step 2204, ancestral path name registration portion 104 divides the ancestral path name of an element of interest every three levels of hierarchy. A check is made as to whether each partial ancestral path name obtained by the division has been registered in ancestral path name dictionary 108. If it has been registered, the corresponding ancestral path name ID is gained. If it is not registered, a new ancestral path name ID (>0) is assigned and registered in ancestral path name dictionary 108. If the depth of the ancestral path name is less than 3 levels of hierarchy, the string of the ancestral path name ID is a single ancestral path name ID in the same way as in embodiment 1.

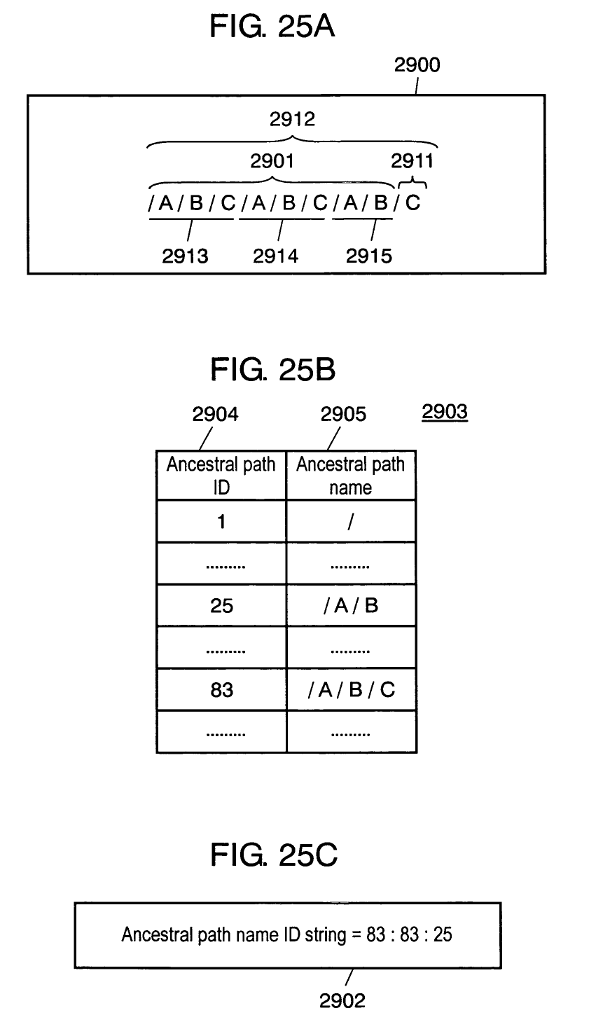

FIG. 25A is a diagram illustrating partial ancestral path names in embodiment 2 of the invention. FIG. 25B is a diagram illustrating the contents of the ancestral path name dictionary. FIG. 25C is a diagram illustrating a string of ancestral path name IDs. In FIG. 25A, ancestral path name 2901 “/A/B/C/A/B/C/A/B/C” obtained by removing element name 2911 from path name 2900 can be further divided into partial path names “/A/B/C” (2913 and 2914) and “/A/B/” (2915). As shown in FIG. 25B, ancestral path ID 2904 of ancestral path name 2905 “/A/B/C” and “/A/B” are registered as “83” and “25”, respectively, in the contents 2903 of ancestral path name dictionary 108. In this case, as shown in FIG. 25C, ancestral path name 2901 can be expressed as ancestral path name ID string 2902 “83:83:25” using ancestral path ID 2904 indicating decomposed each ancestral path name 2905 and symbol “:”.

In this way, already registered ancestral path name ID 2904 can be used in common among the ancestral element of this element and other elements by dividing ancestral path name 2901 and assigning ancestral path name ID 2904 to each partial ancestral path name 2905. Furthermore, the number of overlaps of ancestral path name IDs can be reduced, and the size of ancestral path name dictionary 108 can be reduced.

In the present embodiment, an example in which an ancestral path name is divided every three levels of hierarchy is shown. The method of division is not limited to this. For example, an ancestral path name may be divided every four levels of hierarchy, and the width of division may be varied according to the hierarchical depth. Although symbol “:” is used as a character for partitioning a string of ancestral path name IDs, other partitioning symbol may also be used.

If elements of interest have attributes, attribute name registration portion 105 performs processing for registering the attributes of the elements of interest in attribute name dictionary 109 in steps 2205 to 2206, in the same way as in embodiment 1.

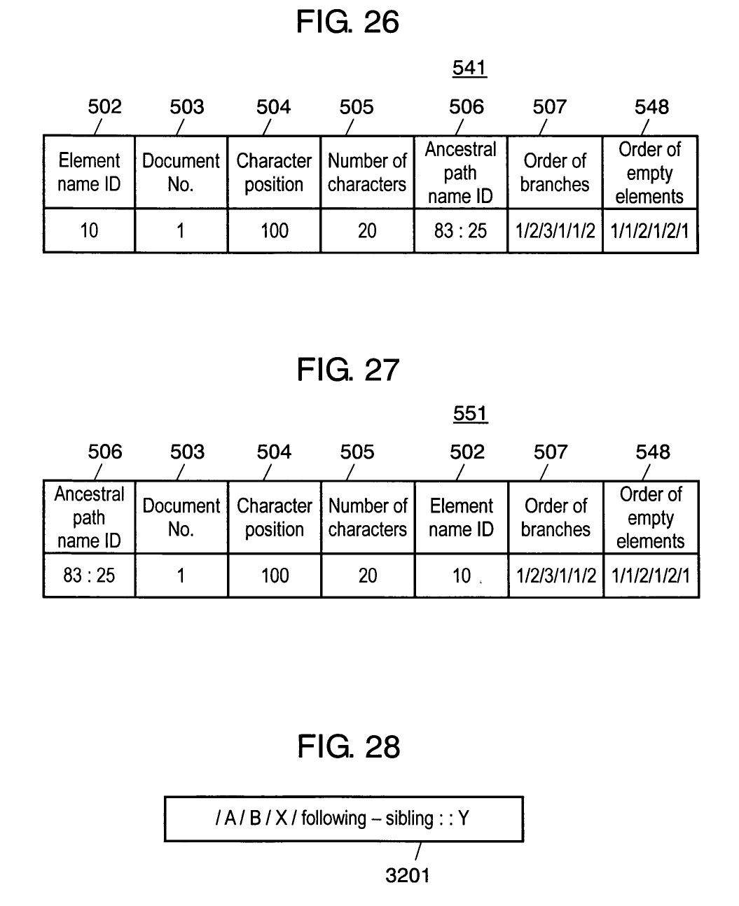

In step 2207, appearance information registration portion 106 registers information about the appearance of elements regarding the elements of interest in element appearance information storage portion 111 using element name IDs as keys. The information about the appearance of elements is made up of sets of the values of the following six kinds: document number, the position of the forefront character of the text contained in the element of interest (including descendant elements but excluding tags) and the number of characters, string of ancestral path name IDs, order of branches, and order of empty elements. “Character position” indicates the position of the character counted from the forefront in a string of characters obtained by connecting together all texts within the document excluding tags. Where the element of interest is an empty element, the first character position of the text (excluding tags) initially appearing after the element of interest is regarded as the initial character position of the element of interest. One example of the information about the appearance of elements is shown in FIG. 26. FIG. 26 is a diagram illustrating the information about the appearance of elements in embodiment 2 of the present invention. The differences with embodiment 1 are that a string of ancestral path name IDs obtained by concatenating together more than one ancestral path name ID with partitioning characters is recorded in ancestral path name 506 of element appearance information 541 rather than single ancestral path name ID and that information about the order of empty elements 548 is included.

In step 2208, appearance information registration portion 106 registers ancestral path appearance information about an element of interest in ancestral path appearance information storage portion 112 using the string of ancestral path name IDs as a key. The information about appearance of ancestral paths is made up of sets of the values of the following six types: document number, the position of the forefront character of the text (excluding tags) included in the element of interest (including a descendant element) and the number of characters, element name ID, order of branches, and order of empty elements. One example of the information about appearance of ancestral paths is shown in FIG. 27. FIG. 27 is a diagram illustrating information about the appearance of ancestral paths in embodiment 2 of the present invention. The differences with embodiment 1 are that information about appearance of ancestral paths 551 includes information about the order of empty elements 548 and that a string of ancestral path name IDs obtained by concatenating together more than one ancestral path name ID with partitioning characters is registered in ancestral path name ID 506 rather than a single ancestral path name ID.

If the element of interest has an attribute, appearance information registration portion 106 registers attribute appearance information regarding the attributes of the element of interest in attribute appearance information storage portion 113 using the attribute name IDs as keys. The information about appearance of attributes is made up of sets of the values of the following seven kinds: document number, the position of the forefront character of attribute values and the number of characters, string of ancestral path name IDs, element name ID, order of branches, and order of empty elements. The differences with embodiment 1 are that a string of ancestral path name IDs obtained by concatenating together more than one ancestral path name ID with partitioning characters about the information is recorded in the ancestral path name ID about attribute appearance information instead of a single ancestral path name ID and that information about the order of empty elements is included.

In step 2211, appearance information registration portion 106 extracts partial character strings from the text of the entity contents of the element of interest and registers information about appearance of the text in text appearance information storage portion 114 using the extracted partial character strings as keys. Since the information about the appearance of the text is not an attribute value, value “0” is always stored in the attribute name ID. The information about the appearance of the text is made up of sets of the values of the following seven kinds: document number, the position of the forefront character of the extracted partial character string, string of ancestral path name IDs, element name ID, attribute name ID, order of branches, and order of empty elements. The differences with embodiment 1 are that a string of ancestral path name IDs obtained by concatenating together more than one ancestral path name ID with partitioning characters is recorded in the ancestral path name ID about the information about the appearance of the text rather than a single ancestral path name ID and that information about the order of empty elements is included.

If the element of interest has attributes, appearance information registration portion 106 extracts partial character strings from attribute value character strings of the attributes possessed by the element of interest and registers the extracted strings in text appearance information storage portion 114 using the partial character strings as keys in steps 2212 to 2213. In the same way as in step 2211, the differences with embodiment 1 are that a string of ancestral path name IDs obtained by concatenating together more than one ancestral path name ID with partitioning characters is registered in the information about the text appearance rather than a single ancestral path name ID and that information about the order of empty elements is included.

Subsequently, steps 2214 to 2215 are carried out in the same way as in embodiment 1 to register documents and build a database.

Processing for searching already registered plural documents is next described. Search processing using a search formula similar in format with the search formula shown in embodiment 1 can be realized by modifying the processing performed by search condition analysis portion 117 to convert the search formula into internal conditions after finding ancestral path name IDs from ancestral path names to processing for finding a string of ancestral path name IDs from ancestral path names. That is, search condition analysis portion 117 divides each ancestral path name every three levels of hierarchy, finds an ancestral path name ID corresponding to each partial ancestral path name obtained by the division while referring to ancestral path name dictionary 108, and arrays the ancestral path name IDs while partitioning them with partitioning characters in turn, thus finding a string of ancestral path name IDs. The format of the string of ancestral path name IDs is similar to the format shown in FIGS. 25A-25C in the description of processing for document registration. Where the depth of ancestral path names is less than three levels of hierarchy, a single ancestral path name ID occurs. In embodiment 1, appearance information acquisition portion 118 performs various processing steps for collation with ancestral path name IDs. The search results can be found by modifying these processing steps to a method of consisting of making checks with a string of ancestral path name IDs.

(In the Case of Search Formula 3201)

FIG. 28 is a diagram illustrating an example of search formula in embodiment 2 of the present invention. Search formula 3201 shown in FIG. 28 indicates “Y element which is a sibling element of X element that is a child of B element that is a child of A element at the highest level of hierarchy and which appears behind X element”. Search formula 3201 is entered from search condition input portion 116. Search condition analysis portion 117 analyzes search formula 3201, converts the formula into internal conditions while referring to element name dictionary 107 and ancestral path dictionary 108, and outputs the formula to appearance information acquisition portion 118. The internal conditions are “C1 and (C2 or C3) where Cx: {ancestral path name ID=25 and element name ID=10}, Cy: {ancestral path name ID=25 and element name ID=14}, C1: {Cx and Cy are identical in document number and their orders of branches are identical except for their ends}, C2: {Cy is greater than Cx in value of character position}, C3: {Cx and Cy are identical in value of character position and Cy is greater than Cx in value of end of order of empty elements}”. The ancestral path name ID corresponding to ancestral path name “/A/B” is 25. The element name ID corresponding to element name “X” is “10”. Element name ID corresponding to element name “Y” is “14”. The reason why condition C3 is necessary in the internal conditions is that an empty element and an immediately following element are identical in character position and so the values of order of empty elements must be compared to judge which one is in front of the other.

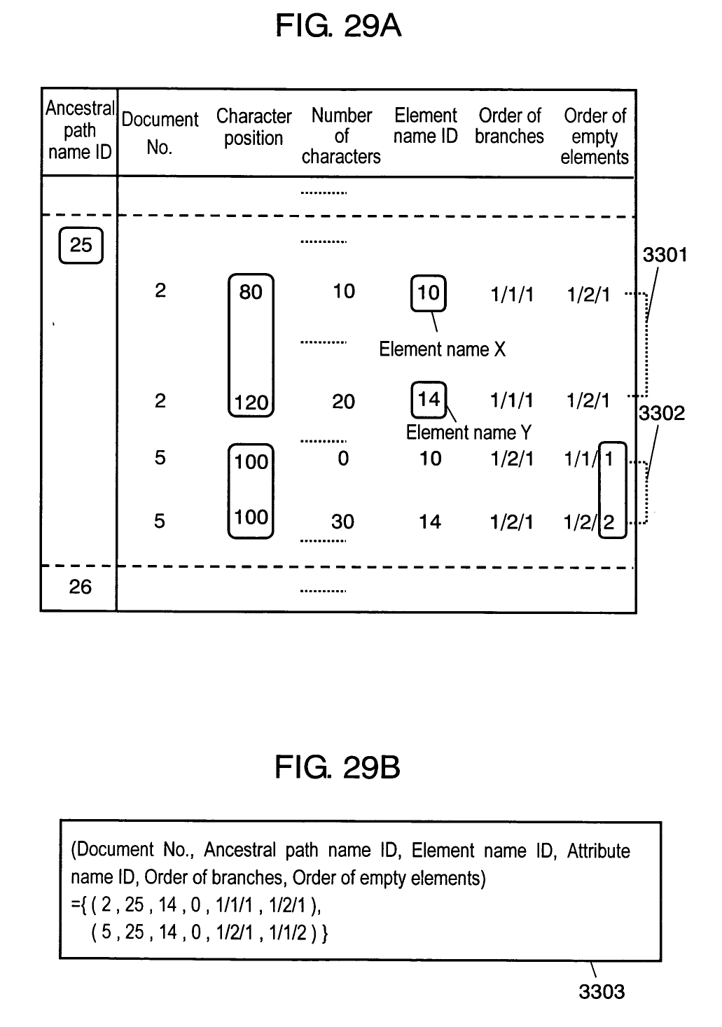

The search operation in embodiment 2 of the present invention is described. Appearance information acquisition portion 118 refers to appearance position index 110 and finds entries which have ancestral path name IDs of 25 in ancestral path appearance information storage portion 112 and which have element name IDs of 10 (Cx) and entries having element name IDs of 14 (Cy) as shown in FIG. 29A. Subsequently, the portion finds sets 3301 and 3302 of entries of Cx and Cy which satisfy C1 and (C2 or C3). Appearance information acquisition portion 118 outputs the found sets as result data aggregate 3303, for example, in the format (document number, ancestral path name ID, element name ID, attribute name ID, order of branches, and order of empty elements) to search result output portion 119 as shown in FIG. 29B. Search result output portion 119 outputs the result of the search in an appropriate format, for example, by gaining document entities of the found result data aggregate.

When entries of Cx and Cy are found, the number of entries of specified ancestral path name IDs in ancestral path appearance information storage portion 112 and the number of entries of specified element name IDs in element appearance information storage portion 111 may be compared and the smaller one may be selected.

In this way, the database apparatus in the present embodiment can find search results correctly using search formula 3201 by comparing information about the orders of empty elements and eliminating ambiguity in their positional relationship even if the appearance positions of two elements found by referring to ancestral path appearance information storage portion 112 or element appearance information storage portion 111 are the same, i.e., if one of the two elements is an empty element and the other is an element located immediately behind it.

As described so far, in the database apparatus in the present embodiment, ancestral path name registration portion 104 divides each ancestral path name into partial ancestral path names, assigns a unique ancestral path name ID to each different partial ancestral path name obtained by the division, and registers them in ancestral path name dictionary 108. Therefore, the size of the ancestral path name dictionary can be reduced.

Appearance information registration portion 106 also stores the information about the orders of empty elements in element appearance information storage portion 111, ancestral path appearance information storage portion 112, attribute appearance information storage portion 113, and text appearance information storage portion 114. Therefore, the database apparatus in the present embodiment can find correct search results by eliminating ambiguity in the positional relationship along a line (i.e., an empty element and an element located immediately behind it are identical in start character position).

As such, the database apparatus in the present embodiment regards the position of the first character of the text initially appearing after the element of interest as the position of the first character of the element of interest in a case where the elements of the structured element are empty elements containing no text at all. Consequently, the order of appearance of empty elements is created as an index of appearance positions. It is possible to efficiently search a document indicated by a search formula indicative of a document structure containing empty elements, as well as full text search of a structured document structure, in a case where empty elements are continuously contained, as well as in a case where empty elements are contained in a structured document.

The database apparatus in the present embodiment registers an ancestral path name as a string of ancestral paths based on partial path names obtained by division under certain conditions. Therefore, the database apparatus in the present embodiment does not store partial paths duplicately and, consequently, can reduce the size of the ancestral path dictionary. In addition, even if it is a structured document containing many subjects to be structured, the document given by the search formula showing a document structure can be efficiently searched.

The database apparatus in the present embodiment is designed to realize first and second configurations at the same time. In the first configuration, when a structured document is registered, the document structure is analyzed, and dictionary data and appearance position index data are created. Thus, the structured document is registered. In the second figuration, with respect to documents shown in a search formula indicating the accepted document structure, the registered documents are efficiently searched based on the dictionary data and appearance position index data. However, the apparatus is designed to have only the configuration performing the function of registering structured documents or the configuration only for search.

The database apparatus in the present embodiment is designed to achieve first and second configurations at the same time. In the first configuration, when a structured document is registered, appearance position index data corresponding to empty elements having no text elements is created and registered. In the second configuration, dictionary data about partial ancestral path names obtained by dividing each ancestral path name and appearance position index data are created and registered. However, the apparatus may be designed to have the configuration that registers only empty elements or registers only ancestral path names.

### Embodiment 3

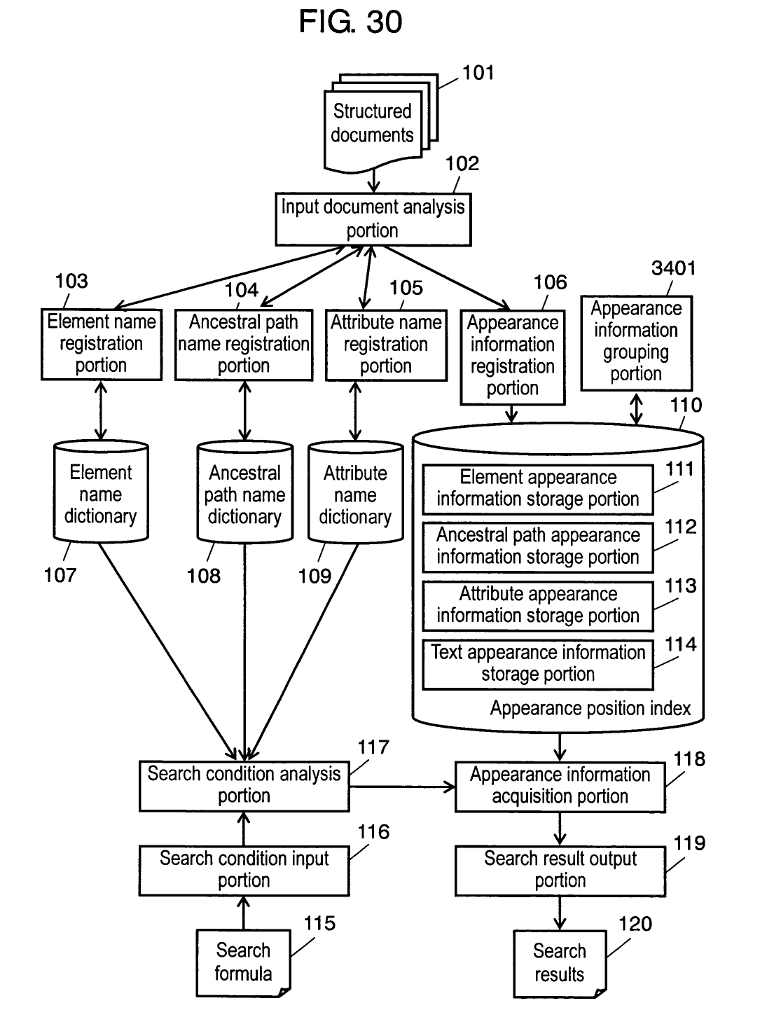

The configuration and operation of a database apparatus in present embodiment 3 are next described. FIG. 30 is a block diagram showing the configuration of the database apparatus in embodiment 3 of the present invention. In FIG. 30, the database apparatus in present embodiment 3 is similar in configuration with embodiment 2 except that appearance information grouping portion 3401 is added to group the information stored in element appearance information storage portion 111, ancestral path appearance information storage portion 112, attribute appearance information storage portion 113, and text appearance information storage portion 114.

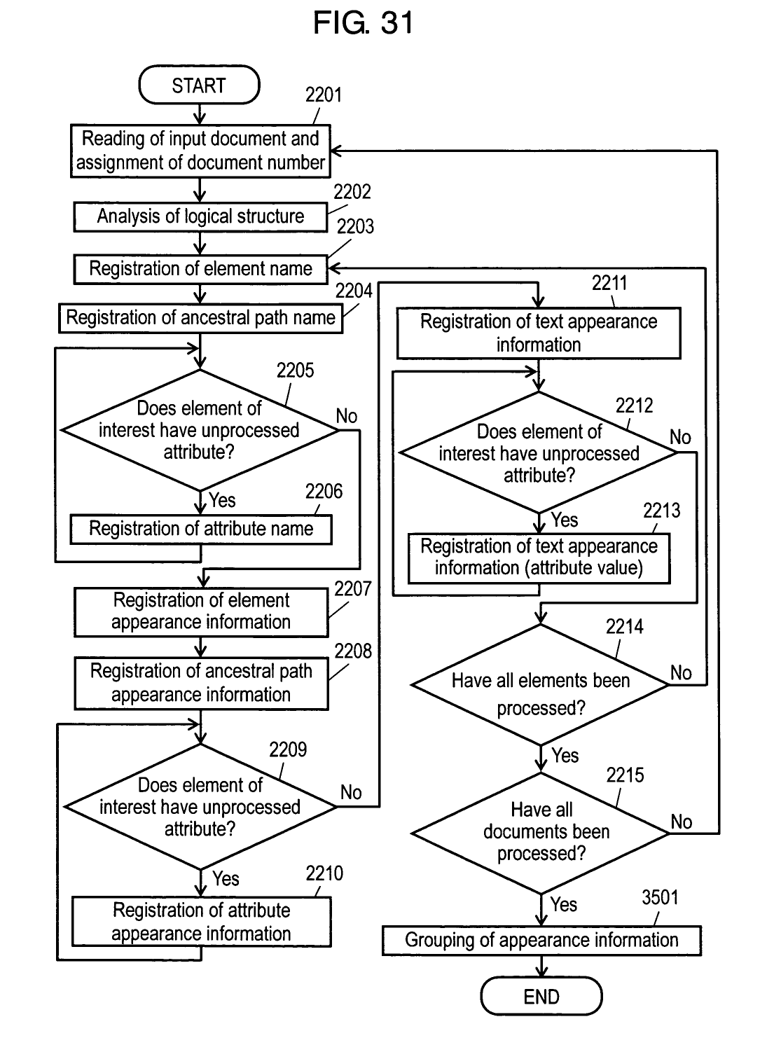

The operation for processing for building a database in which documents are registered is described. FIG. 31 is a flowchart illustrating procedures for processing for registering documents in the database apparatus in embodiment 3 of the present invention. In FIG. 31, the processing given by steps 2201 to 2215 is the same as the processing of embodiment 2 and so its description is omitted.

In final step 3501, appearance information grouping portion 3401 collects entries having common values of four kinds of information items (number of characters, ancestral path name ID, order of branches, and order of empty elements) excluding document number and character position out of entries registered in element appearance information storage portion 111 using the same element name ID as a key and groups the entries if the number of the entries is in excess of a threshold value (e.g., 10 entries). Then, appearance information grouping portion 3401 finds entries having common values of any three kinds of information items out of four kinds of information items (number of characters, ancestral path name ID, order of branches, and order of empty elements) excluding document number and character position concerning the remaining entries, and groups the entries if the number of the entries is in excess of a threshold value. An entry that might belong to plural groups is contained in the group having the greatest number of entries. Appearance information grouping portion 3401 similarly creates groups of entries having common values of any two kinds of information items. Additionally, appearance information grouping portion 3401 creates a group of entries having a common value of any one kind of information item. The entries left behind finally are registered as a group of entries having no common information items.

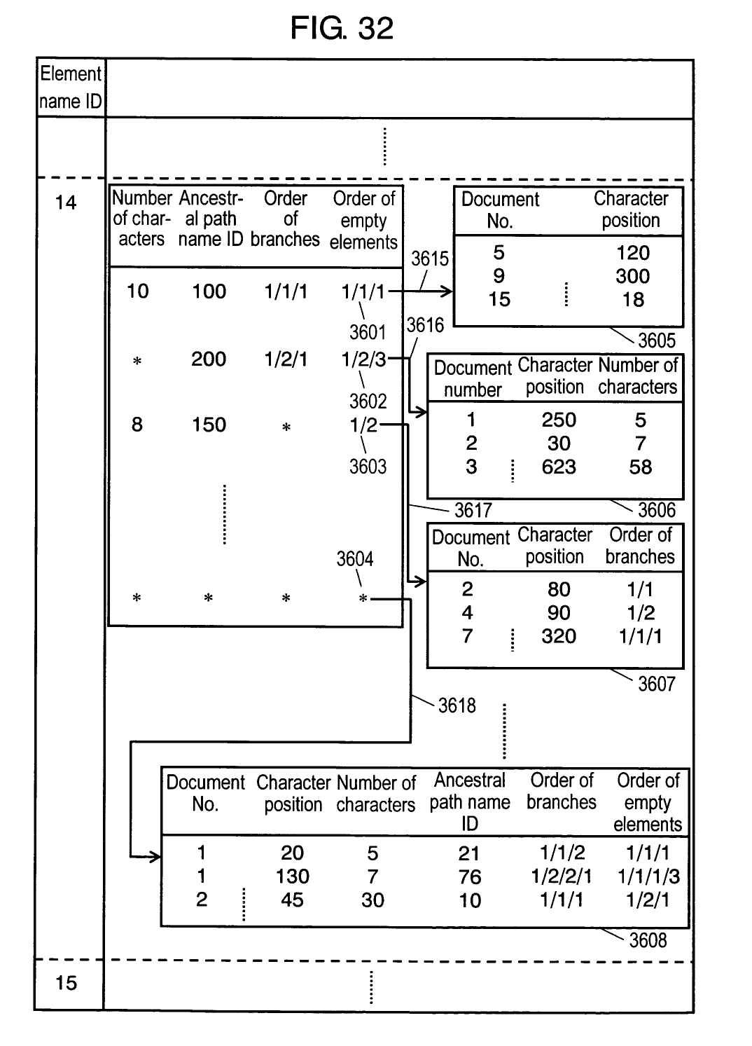

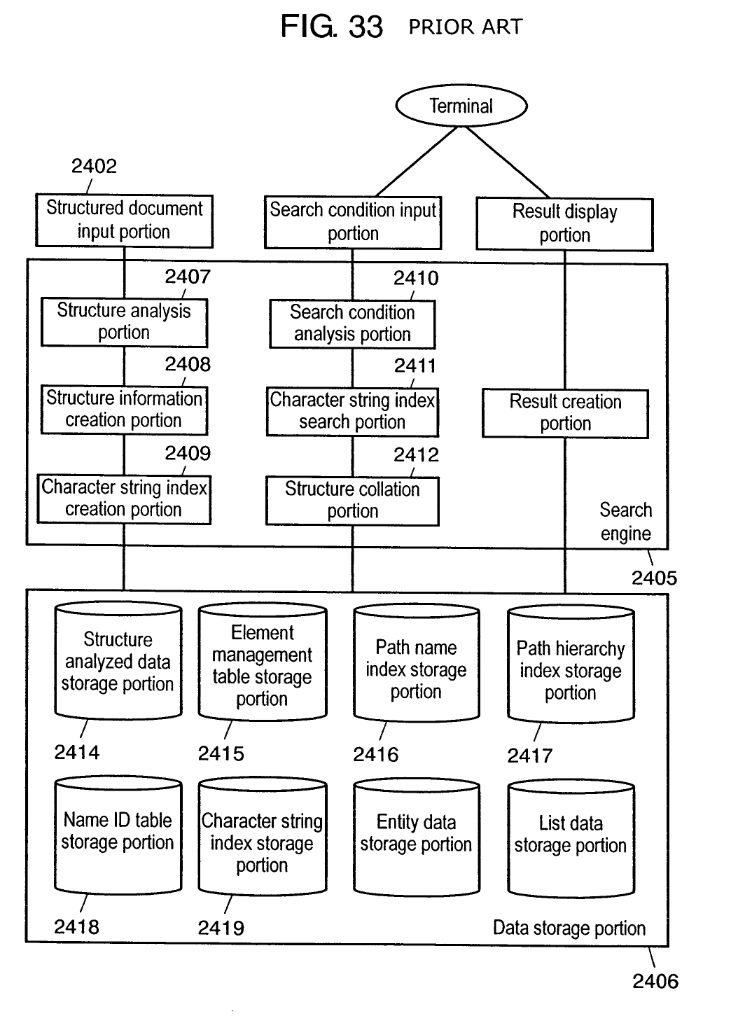

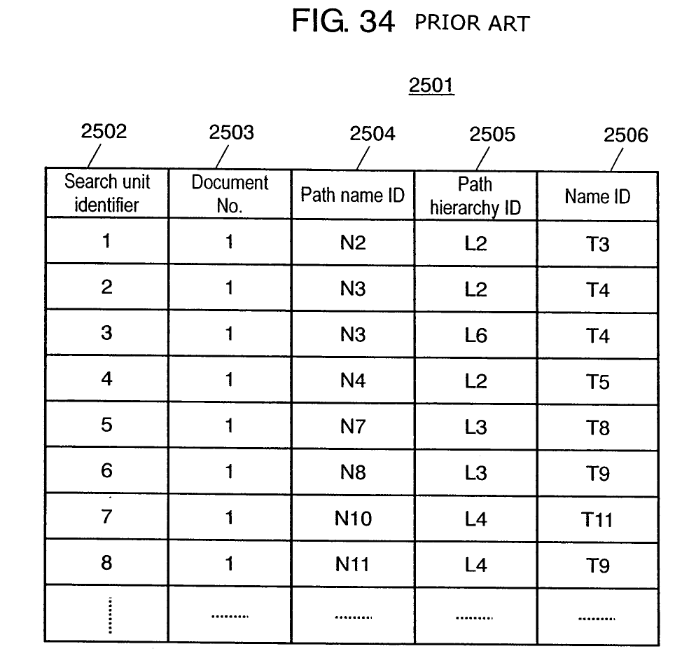

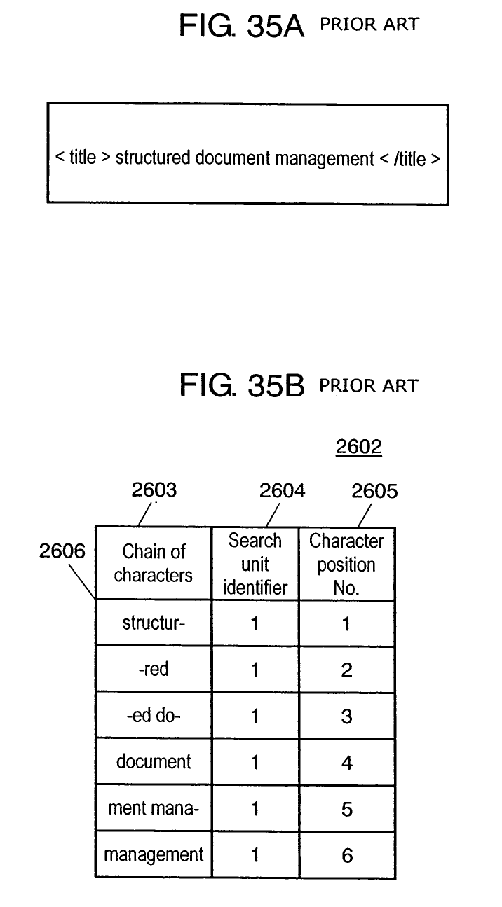

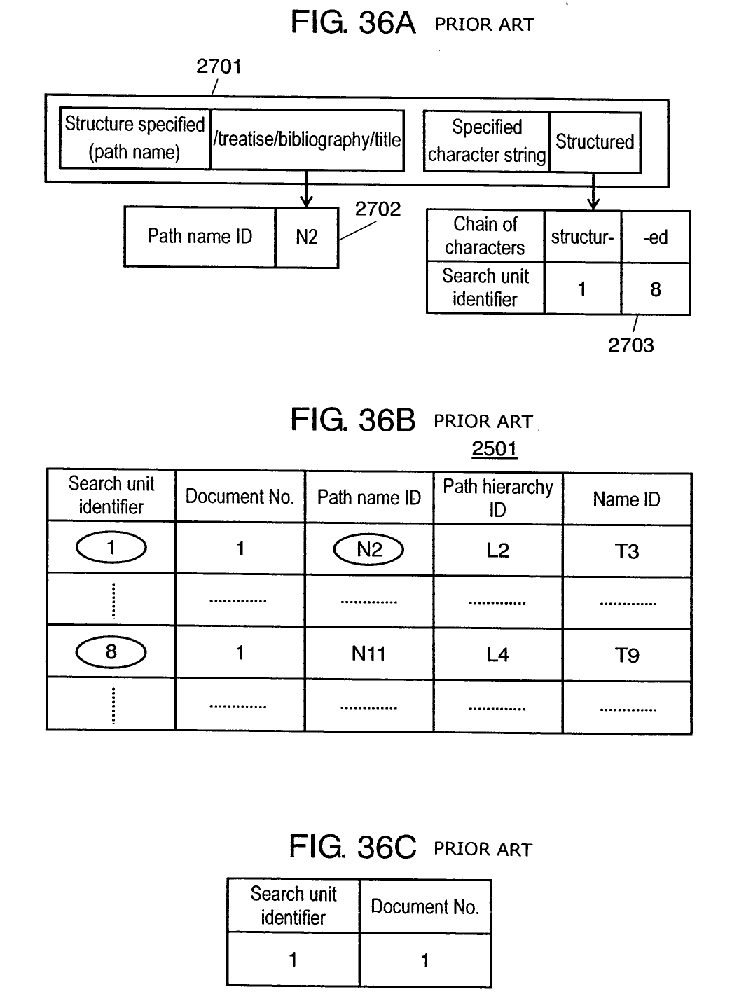

FIG. 32 is a diagram illustrating grouped element appearance information in embodiment 3 of the present invention. In FIG. 32, element appearance information having an element name ID of 14 is grouped, and is made of group information and individual entries. The values of information items that are common among entries 3605-3608 belonging to groups and link information 3615-3618 on links to the individual entries are stored in group information 3601-3604. The values of only non-common information items are stored in individual entries 3605-3608.

With respect to first group information 3601, entries about element appearance information belonging to this group have values of (the number of characters=10, ancestral path name ID=100, order of branches=“1/1/1”, and order of empty elements=“1/1/1”) in common. Each individual entry 3605 belonging to this group stores only its document number and character position. With respect to second group information 3602, entries about element appearance information belonging to this group have values of (ancestral path name ID=200, order of branches=“1/2/1”, and order of empty elements=“1/2/3”) in common. However, an information item about the number of characters and denoted by symbol * indicates that entries do not have common values. The number of characters is stored in each individual entry 3606 together with character number and character position. With respect to third group information 3603, entries about element appearance information belonging to this group have common values of (the number of characters=8, ancestral path name ID=150, and order of empty elements=“½”), and the information item about the order of branches indicated by symbol * indicates that entries do not have common values. The order of branches is stored in each individual entry 3607 together with document number and character position. The group indicated by fourth group information 3604 have no common information item. All information items are stored in each entry 3608.

With respect to each type of information stored in ancestral path appearance information storage portion 112, attribute appearance information storage portion 113, and text appearance information storage portion 114, entries having common values of information items other than document number and character position are grouped, thus completing processing for building a database for registering documents.

Therefore, appearance information acquisition portion 118 of the database apparatus in the present embodiment restores the values of all information items based on the contents of the grouped entries and group information and finds results of search in the same way as in embodiment 2 as processing for searching already registered documents.

In this way, appearance information grouping portion 3401 of the database apparatus in the present embodiment groups entries stored in appearance position index 110, and the values of information items common in the group are bundled. They are not stored in individual entries. Consequently, the database apparatus in the present embodiment can reduce the index size.

In this manner, with respect to appearance position information such as elements and ancestral paths, the database apparatus in the present embodiment groups portions having common values of information items under some conditions and stores them with a structure different from the portions that cannot be made common. Therefore, the index size can be reduced without storing common portions duplicately.

### INDUSTRIAL APPLICABILITY

A database building apparatus according to the present invention can build data used for searching, the data being configured to permit efficient search of structured documents. The database building apparatus is useful for a database apparatus that enables efficient search.

1. A database building apparatus for managing structured documents, the database building apparatus comprising:
an input document analysis portion for assigning a unique document number to each structured document and analyzing its structure;
an element name registration portion for assigning a unique element name ID to each element name appearing in the structured document based on results of the analysis performed by the input document analysis portion and registering the element name in an element name dictionary;
an ancestral path name registration portion for assigning a unique ancestral path name ID to each ancestral path name appearing in the structured document based on the results of the analysis performed by the input document analysis portion and registering the ancestral path name in an ancestral path name dictionary; and
an appearance information registration portion for registering element appearance information including at least information about a document number at which an element of interest appears, character position, ancestral path name ID, and order of branches in element appearance information storage portion using an element name ID as a key based on the results of the analysis performed by the input document analysis portion and for registering ancestral path appearance information including at least information about the document number at which the element of interest appears, character position, element name ID, and order of branches in an ancestral path appearance information storage portion using the ancestral path name ID as a key.

2. The database building apparatus of claim 1, further including an attribute name registration portion for assigning a unique attribute name ID to each attribute name appearing in the structured document based on the results of the analysis performed by the input document analysis portion and registering the attribute name in an attribute name dictionary,
wherein the appearance information registration portion registers attribute appearance information including at least information about a document number at which an attribute of interest appears, character position, ancestral path name ID, element name ID, and order of branches in an attribute appearance information storage portion using the attribute name ID as a key based on the results of the analysis performed by the input document analysis portion.

3. The database building apparatus of claim 1, wherein the appearance information registration portion registers text appearance information including at least information about appearing document number, character position, ancestral path name ID, element name ID, attribute name ID, and order of branches regarding partial character strings extracted from element entity text and attribute values in text appearance information storage portion using the extracted partial character strings as keys based on the results of the analysis performed by the input document analysis portion.

4. The database building apparatus of claim 1, wherein the element appearance information includes at least information about a document number at which an element of interest appears, character position, ancestral path name ID, order of branches, and order of empty elements, and wherein the ancestral path appearance information includes at least information about the document number at which the element of interest appears, character position, element name ID, order of branches, and order of empty elements.

5. The database building apparatus of claim 2,
wherein the element appearance information includes at least information about the document number at which the element of interest appears, character position, ancestral path name ID, order of branches, and order of empty elements;
wherein the ancestral path appearance information includes at least information about the document number at which the element of interest appears, character position, element name ID, order of branches, and order of empty elements; and
wherein the attribute appearance information includes at least information about the document number at which the attribute of interest appears, character position, ancestral path name ID, element name ID, order of branches, and order of empty elements.

6. The database building apparatus of claim 3,
wherein the element appearance information includes at least information about the document number at which the element of interest appears, character position, ancestral path name ID, order of branches, and order of empty elements;
wherein the ancestral path appearance information includes at least information about the document number at which the element of interest appears, character position, element name ID, order of branches, and order of empty elements; and
wherein the text appearance information includes at least information about appearing document number, character position, ancestral path name ID, element name ID, attribute name ID, order of branches, and order of empty elements regarding partial character strings extracted from element entity text and attribute values.

7. The database building apparatus of claim 1, wherein the ancestral path name registration portion assigns a unique ancestral path name ID to each partial ancestral path name obtained by dividing each ancestral path name appearing in the structured document into more than one partial ancestral path name and registers the partial ancestral path name in the ancestral path name dictionary.

8. The database building apparatus of claim 1, further including an appearance information grouping portion for grouping entries having common values of more than one information item other than document number and character position regarding entries of the element appearance information registered in the element appearance information storage portion using the same element name ID as a key and entries of the ancestral path appearance information registered in the ancestral path appearance information storage portion using the same ancestral path name ID as a key.

9. A database search apparatus for managing structured documents, the database search apparatus comprising:
an element name dictionary in which a unique element name ID has been registered for each element name appearing in each structured document;
an ancestral path name dictionary in which a unique ancestral path name ID has been registered for each ancestral path name appearing in the structured document;
an element appearance information storage portion in which element appearance information has been stored using an element name ID as a key based on results of analysis of the structured document, the element appearance information including at least information about a document number at which an element of interest appears, character position, ancestral path name ID, and order of branches;
an ancestral path appearance information storage portion in which ancestral path appearance information has been stored using an ancestral path name ID as a key based on the results of the analysis of the structured document, the ancestral path appearance information including at least information about the document number at which the element of interest appears, character position, element name ID, and order of branches;
a search condition input portion for entering a search formula;
a search condition analysis portion for converting the input search formula into an internal condition formula by referring to the element name dictionary and the ancestral path name dictionary; and
an appearance information acquisition portion for finding plural search results from element appearance information from the element appearance information storage portion and from ancestral path appearance information from the ancestral path appearance information storage portion according to the internal condition formula output by the search condition analysis portion.

10. The database search apparatus of claim 9, further including:
an attribute name dictionary in which attribute name IDs and corresponding attribute names are recorded; and
an attribute appearance information storage portion in which attribute appearance information is stored using the attribute name IDs as keys, the attribute appearance information including at least information about a document number at which an attribute of interest appears, character position, ancestral path name ID, element name ID, and order of branches;
wherein the search condition analysis portion converts a search formula entered from the search condition input portion into internal condition formulas while referring to the element name dictionary and the ancestral path name dictionary; and
wherein the appearance information acquisition portion finds plural search results from element appearance information from the element appearance information storage portion, ancestral path appearance information from the ancestral path appearance information storage portion, and attribute appearance information from the attribute appearance information storage portion according to the internal condition formula output by the search condition analysis portion.

11. The database search apparatus of claim 9, further including a text appearance information storage portion in which text appearance information is stored using extracted partial character strings as keys regarding the partial character strings extracted from element entity text and attribute values, the text appearance information including at least information about appearing document number, character position, ancestral path name ID, element name ID, attribute name ID, and order of branches;
wherein the appearance information acquisition portion finds plural search results from element appearance information from the element appearance information storage portion, ancestral path appearance information from the ancestral path appearance information storage portion, and text appearance information from the text appearance information storage portion according to the internal condition formula output by the search condition analysis portion.

12. The database search apparatus of claim 9, wherein the appearance information acquisition portion compares the number of entries of a specified element name ID in the element appearance information storage portion and the number of entries of a specified ancestral path name ID in the ancestral path appearance information storage portion, refers to appearance information having the fewer number of entries, and finds plural search results.

13. A method of constructing a database for managing structured documents, the method comprising the steps of:
assigning a unique document number to each structured document and analyzing its structure;
assigning a unique element name ID to each element name appearing in the structured document based on results of the analysis and registering the element name in an element name dictionary;
assigning a unique ancestral path name ID to each ancestral path name appearing in the structured document based on results of the analysis and registering the ancestral path name ID in an ancestral path name dictionary; and
registering element appearance information including at least information about a document number at which an element of interest appears, character position, ancestral path name ID, and order of branches into an element appearance information storage portion using an element name ID as a key based on the results of the analysis and registering ancestral path appearance information including at least information about the document number at which the element of interest appears, character position, element name ID, and order of branches into an ancestral path appearance information storage portion using an ancestral path name ID as a key.

14. The method of claim 13, wherein the element appearance information includes at least information about the document number at which the element of interest appears, character position, ancestral path name ID, order of branches, and order of empty elements, and wherein the ancestral path appearance information includes at least information about the document number at which the element of interest appears, character position, element name ID, order of branches, and order of empty elements.

15. The method of claim 13,
wherein the registering step into the ancestral path name dictionary consists of assigning a unique ancestral path name ID to each partial ancestral path name obtained by dividing each ancestral path name appearing in each structured document into more than one partial ancestral path name and registering the partial ancestral path name;
wherein the element appearance information includes a string of more than one ancestral path name ID instead of a single ancestral path name ID; and
wherein the ancestral path appearance information is registered in the ancestral path appearance information storage portion using a string of more than one ancestral path name ID as a key instead of a single ancestral path name ID.

16. The method of claim 13, further including the steps of:
grouping entries of the element appearance information having common values of information items other than document number and character position, the entries being registered in the element appearance information storage portion using the same element name ID as a key; and
grouping entries of the ancestral path appearance information having common values of information items other than document number and character position, the entries being registered in the ancestral path appearance information storage portion using the same ancestral path name ID as a key.

17. A method of searching a database for managing structured documents by the use of a database search apparatus, the database search apparatus having:
an element name dictionary in which an element name ID unique to each element name appearing in each structured document has been registered;
an ancestral path name dictionary in which an ancestral path name ID unique to each ancestral path name appearing in the structured document has been registered;
an element appearance information storage portion in which element appearance information is stored using an element name ID as a key based on results of analysis of the structured document, the element appearance information including at least information about a document number at which an element of interest appears, character position, ancestral path name ID, and order of branches; and
ancestral path appearance information storage portion in which ancestral path appearance information is stored using an ancestral path name ID as a key based on the results of the analysis of the structured document, the ancestral path appearance information including at least information about the document number at which the element of interest appears, character position, element name ID, and order of branches;
the method comprising the steps of:
entering a search formula;
converting the entered search formula into internal condition formulas while referring to the element name dictionary and the ancestral path name dictionary; and
finding plural search results from element appearance information from the element appearance information storage portion and from ancestral path appearance information from the ancestral path appearance information storage portion according to the internal condition formulas.

18. A database apparatus for managing structured documents, the database apparatus comprising:
a database constructing apparatus having
an element name dictionary for storing an element name ID unique to each element name appearing in each structured document,
an ancestral path name dictionary for storing an ancestral path name ID unique to each ancestral path name appearing in the structured document,
an input document analysis portion for assigning a unique document number to the structured document and analyzing its structure,
an element name registration portion for assigning a unique element name ID to each element name appearing in the structured document based on results of analysis performed by the input document analysis portion and registering the element name in the element name dictionary,
an ancestral path name registration portion for assigning a unique ancestral path name ID to each ancestral path name appearing in the structured document based on the results of the analysis performed by the input document analysis portion and registering the ancestral path name in the ancestral path name dictionary,
an element appearance information storage portion for storing element appearance information including at least information about document number, character position, ancestral path name ID, and order of branches using an element name ID as a key,
an ancestral path appearance information storage portion for storing ancestral path appearance information including at least information about document number, character position, element name ID, and order of branches using an ancestral path name ID as a key, and
an appearance information registration portion for registering element appearance information including at least information about the document number at which the element of interest appears, character position, ancestral path name ID, and order of branches into the element appearance information storage portion using the element name ID of the element of interest as a key based on the results of the analysis performed by the input document analysis portion and registering ancestral path appearance information including at least information about the document number at which the element of interest appears, character position, element name ID, and order of branches into the ancestral path appearance information storage portion using the ancestral path name ID of the element of interest as a key; and
a database search apparatus having
a search condition input portion for entering a search formula,
a search condition analysis portion for converting the search formula entered by the search condition input portion into an internal condition formula in which element name and ancestral path name are expressed by element name ID and ancestral path name ID, respectively, while referring to the element name dictionary and the ancestral path name dictionary, and
an appearance information acquisition portion for extracting data about plural search results complying with the internal condition formula created by the search condition analysis portion from the element appearance information stored in the element appearance information storage portion and from the ancestral path appearance information stored in the ancestral path appearance information storage portion.

19. The database apparatus of claim 18, further including:
an attribute name dictionary for storing attribute name IDs and corresponding attribute names;
an attribute name registration portion for assigning a unique attribute name ID to each attribute name appearing in the structured document based on results of analysis performed by the input document analysis portion and registering the attribute name in the attribute name dictionary; and
an attribute appearance information storage portion for storing attribute appearance information including at least information about document number, character position, ancestral path name ID, element name ID, and order of branches using the attribute name ID as a key;
wherein the appearance information registration portion further registers attribute appearance information in the attribute appearance information storage portion using the attribute name ID as a key based on the results of the analysis performed by the input document analysis portion, the attribute appearance information including at least information about a document number at which an attribute of interest appears, character position, ancestral path name ID, element name ID, and order of branches;
wherein the search condition analysis portion further converts the search formula entered by the search condition input portion into an internal condition formula in which the attribute name is expressed by an attribute ID while referring to the attribute name dictionary; and
wherein the appearance information acquisition portion further extracts data about plural search results complying with the internal condition formula output by the search condition analysis portion from element output information stored in the element appearance information storage portion, ancestral path appearance information stored in the ancestral path appearance information storage portion, and attribute appearance information stored in the attribute appearance information storage portion.
